(19) United States
(12) Patent Application Publication
(10) Pub. No.: US 2020/0139742 A1
(43) Pub. Date: May 7, 2020

(54) OPTICAL DEVICES AND METHODS FOR THEIR MANUFACTURE

(71) Applicant: DE LA RUE INTERNATIONAL LIMITED, Basingstoke, Hampshire (GB)

(72) Inventor: Adam LISTER, Andover (GB)

(73) Assignee: DE LA RUE INTERNATIONAL LIMITED, Basingstoke, Hampshire (GB)

(21) Appl. No.: 16/625,178

(22) PCT Filed: May 23, 2018
(86) PCT No.: PCT/GB2018/051402

§ 371 Date: Dec. 20, 2019

(30) Foreign Application Priority Data
Jul. 4, 2017 (GB) 1710688.1

(51) Int. Cl. B42D 25/324; B42D 25/21; B42D 25/355; B42D 25/425; B41M 3/14

(52) U.S. Cl. CPC B42D 25/324; B42D 25/21; B42D 25/373; B42D 25/425; B41M 3/14; B42D 25/355

(57) ABSTRACT

An optical device is disclosed, comprising: a colour layer which comprises elongate strips of at least two different colours alternating with one another periodically along a direction of colour periodicity, the elongate strips extending along the direction which is orthogonal to the direction of colour periodicity; and a light redirecting layer overlapping the colour layer, and defining at least a first image to be exhibited by the optical device. The light redirecting layer comprises at least a first array of refractive and/or reflective anisotropic light redirecting elements extending across a first region of the light redirecting layer and being absent elsewhere, the anisotropic light redirecting elements of the first array each having a primary axis orientated along a first direction lying in the plane of the optical device and being configured such that an incident light beam lying in a plane perpendicular to the first direction and from a light source off the normal of the optical device will be redirected by the anisotropic light redirecting elements towards the normal of the optical device but within the same plane, whereas an incident light beam lying in a plane which is not perpendicular to the first direction and from a light source off the normal of the optical device will either not be redirected, or will be redirected by the anisotropic light redirecting elements out of the plane of the incident light beam.

This invention relates to optical devices, which display one or more images upon illumination with light. Optical devices have a wide range of applications, including decorative uses. A particularly preferred form of optical device to which the invention can be applied is a security device. Security devices are used for example on documents of value such as banknotes, cheques, passports, identity cards, certificates of authenticity, fiscal stamps and other secure documents, in order to confirm their authenticity. Methods of manufacturing optical devices are also disclosed.

Optical devices of the sorts disclosed herein find application in many industries. For example, decorative optical devices having a purely aesthetic function may be applied to packaging to enhance its appearance, or similarly to articles such as mobile phone covers, greetings cards, badges, stickers and the like.

Devices in accordance with the invention find particular utility however in the field of security devices and so the disclosure will focus on this aspect hereinafter.

Articles of value, and particularly documents of value such as banknotes, cheques, passports, identification documents, certificates and licences, are frequently the target of counterfeiters and persons wishing to make fraudulent copies thereof and/or changes to any data contained therein. Typically such objects are provided with a number of visible security devices for checking the authenticity of the object. By “security device” we mean a feature which it is not possible to reproduce accurately by taking a visible light copy, e.g. through the use of standardly available photocopying or scanning equipment. Examples include features based on one or more patterns such as microtext, fine line patterns, latent images, venetian blind devices, lenticular devices, moiré interference devices and moiré magnification devices, each of which generates a secure visual effect. Other known security devices include holograms, watermarks, embossings, perforations and the use of colour-shifting or luminescent/fluorescent inks. Common to all such devices is that the visual effect exhibited by the device is extremely difficult, or impossible, to copy using available reproduction techniques such as photocopying. Security devices exhibiting non-visible effects such as magnetic materials may also be employed.

One class of optical devices are those which produce an optically variable effect, meaning that the appearance of the device is different at different angles of view and/or illumination. Such devices are particularly effective since direct copies (e.g. photocopies) will not produce the optically variable effect and hence can be readily distinguished from genuine devices. Optically variable effects can be generated based on various different mechanisms, including holograms and other diffractive devices, moiré interference and other mechanisms relying on parallax such as venetian blind devices, and also devices which make use of focusing elements such as lenses, including moiré magnifier devices, integral imaging devices and so-called lenticular devices.

Moiré magnifiers and integral imaging devices essentially utilise an array of focussing elements to synthetically magnify a corresponding array of microimages. As the viewing angle (i.e. the angle between the viewer and the normal to the device) is changed, each focussing element magnifies a different portion of the underlying microimage array with the result that the magnified image appears to move laterally, optionally floating above or below the device plane, upon tilting. Lenticular devices on the other hand do not rely upon magnification, synthetic or otherwise. An array of focusing elements, such as cylindrical lenses, overlies a corresponding array of image sections, or “slices”, each of which depicts only a portion of an image which is to be displayed. Image slices from two or more different images are interleaved and, when viewed through the focusing elements, at each viewing angle, only selected image slices will be directed towards the viewer. In this way, different composite images can be seen at different viewing angles (i.e. the angle between the viewer and the normal to the device). Lenticular devices have the advantage that different images can be displayed at different viewing angles, giving rise to the possibility of animation and other striking visual effects which are not possible using the moiré magnifier or integral imaging techniques. However, arrays of lenses suitable for making lenticular devices are becoming more readily available, especially at larger dimensions intended for decorative objects rather than security elements, with the result that certain types of lenticular device are becoming relatively commonplace.

New optical devices are constantly being sought in order to achieve more distinctive and recognisable optical effects and especially, in the field of security devices, to stay ahead of counterfeiters.

In accordance with the present invention, an optical device comprises:
a colour layer which comprises elongate strips of at least two different colours alternating with one another periodically along a direction of colour periodicity, the elongate strips extending along the direction which is orthogonal to the direction of colour periodicity; and
a light redirecting layer overlapping the colour layer, and defining at least a first image to be exhibited by the optical device, the light redirecting layer comprising at least a first array of refractive and/or reflective anisotropic light redirecting elements extending across a first region of the light redirecting layer and being absent elsewhere, the anisotropic light redirecting elements of the first array each having a primary axis orientated along a first direction lying in the plane of the optical device and being configured such that an incident light beam lying in a plane perpendicular to the first direction and from a light source off the normal of the optical device will be redirected by the anisotropic light redirecting elements towards the normal of the optical device but within the same plane, whereas an incident light beam lying in a plane which is not perpendicular to the first direction and from a light source off the normal of the optical device will either not be redirected, or will be redirected by the anisotropic light redirecting elements out of the plane of the incident light beam;
whereby for a viewer substantially on the normal of the optical device, when the incident light beam lies in a plane perpendicular to the first direction and is from a light source off the normal of the optical device, portions of the colour layer which overlap the first region of the light redirecting layer are illuminated by the anisotropic light redirecting elements relative to the remainder of the colour layer;
and wherein the first region is arranged such that, at each location across the first region, the relative proportions of the at least two different colours of the colour layer which are illuminated by the anisotropic light redirecting elements are configured to exhibit in combination a colour of a corresponding pixel of the first image;
such that for a viewer substantially on the normal of the optical device, when the incident light beam lies in a plane perpendicular to the first direction and is from a light source off the normal of the optical device, a colour version of the first image will be exhibited by the device.

Unlike lenticular devices, the optically variable effect of the disclosed optical device relies not on the viewing angle, but on the illumination angle—i.e. the angle at which the incident light strikes the light redirecting layer. Moreover, it is the rotational position of the optical device relative to the light source which determines whether the first image will be exhibited to the viewer, not the “tilt” angle between the incident light beam and the device normal. Provided the light source is off the device normal, then if the incident light strikes the light redirection layer at an angle substantially perpendicular to the primary axis of the anisotropic light redirecting elements then they will redirect the light towards the normal and illuminate the first image over a wide range of incident light “tilt” angles. However, as the device is rotated (or, analogously, the light source is moved around the device), the first image will appear to switch on and off as the incident light beam strikes the first array of light redirecting elements at varying angles. This manner of manipulating the optical device to reveal the optically variable effect is quite different from that required to see the optically variable effect of conventional optical devices such as lenticular devices, moiré magnifiers and the like and ensures that the new effect is distinct and at the same time cannot be imitated by such known devices. Depending on the construction of the device, the effect could be visualised on viewing in transmitted light and/or in reflected light.

As will be described in greater detail below, the anisotropic light redirecting elements are passive structures such as prisms or the like, which act on incoming light in the manner described above, which is dependent on the incident illumination direction relative to the elements' orientation. All of the elements making up the first array have the same orientation as one another, with their primary axes aligned in the first direction. It should be noted that the first direction could have any arbitrary orientation in the plane of the device, relative to the orientation of the colour layer. The first array fills the first region of the light redirecting layer such that this same region will appear illuminated (i.e. bright relative to the rest of the layer—that is, there will be a contrast therebetween) when the incident light beam is correctly orientated perpendicular to the first direction.

Outside the first region, there are no functional light redirecting elements with the same orientation as those inside the first region (i.e. the first array is absent), and indeed the remainder of the light redirecting layer could be void of functional light redirecting elements. Optionally, however, functional light redirecting elements with other orientations might be present outside the first region as described further below. It is also possible that non-functional light redirecting elements (i.e. elements which have been modified so that they do not perform as described above, or their effects inhibited, for instance by being “indexed out”) may be present outside the first area, as will also be described below.

The lateral extent of the first region is configured such that the portions of the colour layer which overlap the first region (and hence are illuminated by the first array of light redirecting elements when struck by incident light at the appropriate angle) display, in combination, a first image. Thus, as described in more detail below, each pixel of the image is displayed by one or more parts of the first region acting to illuminate a certain proportion of one or more of the strips in the colour layer so that, together, the desired colour of that pixel is exhibited. It will be appreciated that, depending on the desired colour of the pixel, the proportion of each colour strip that may be illuminated could be anywhere from 0% to 100% (inclusive). The term “pixel” means a portion of the image, but it should be noted that this does not necessarily correspond to the base units of the original image at its original resolution. For instance as described below, a high resolution source image may be “pixelated” to create larger pixels which are then used to form the first region (and hence the displayed first image). It should also be noted that the displayed colour version of the first image may be single-coloured or multi-coloured. This will depend on the nature of the first image. Further, whilst it is generally preferred that the colour version of the first image has substantially the same colour(s) as the original image, this need not always be the case. For instance, as described below, the displayed image could be a false-colour version of the original image.

The ability to display a multi-coloured image in this way represents a further advantage over conventional lenticular devices, in which it is difficult to form the image array in more than one colour due to the very high resolution required. However in the presently disclosed device, the colour layer can be formed in a conventional manner without the need for high resolution since this simply contributes the colour(s) to the displayed image. However, what colour is displayed to the viewer at each point of the image is determined by the light redirecting layer, which can more readily be formed at the necessary high resolution using well-established methods as will be described further below.

As noted above, the refractive and/or reflective anisotropic light redirecting elements could take various different forms, provided they redirect incident light in the described manner by means of refraction and/or reflection (rather than diffraction, for example). Preferably, each anisotropic light redirecting element comprises a structure having at least one planar or curved face which extends uniformly along the primary axis and all or part of which makes a facet angle of more than zero degrees and less than or equal to 90 degrees with the plane of the device. (It will be appreciated that if the at least one face is planar, the whole face will make the same facet angle with the plane of the device, whereas if the at least one face is curved, the facet angle will vary between the base of the element and its top). Facet angles of less than 90 degrees are preferred, but angles of 90 degrees can produce the desired effect, given that the light source will typically be to the side of the note and hence the incident beam will strike a 90 degree facet at a glancing angle. One such planar or curved face to each element is sufficient (for instance, any opposing face could have a facet angle which is greater than 90 degrees). However, it is preferred that each anisotropic light redirecting element comprises a structure having at least two planar or curved faces each as defined above, opposing one another. In this way both faces can contribute to the illumination effect. It should be noted, however, that in this scenario the two faces need not each make the same facet angle with the plane of the device as one another. Further, one could be planar while the other is curved.

The anisotropic light redirecting elements could have faces of the sort described only lying parallel to the primary axis, in which case the first array will only illuminate the colour layer when incident light is perpendicular to the first direction. However, in some preferred embodiments, each anisotropic light redirecting element additionally has a secondary axis in the plane of the device, maxing an angle of more than zero degrees and less than or equal to 90 degrees with the primary axis, and the structure further comprises at least one planar or curved face which extends uniformly along the secondary axis and all or part of which makes a facet angle of more than zero degrees and less than or equal to 90 degrees with the plane of the device. For instance, each light redirecting element could have a square, rectangular or even hexagonal footprint with angled faces provided along each edge. In the case of a square or rectangular footprint, illumination by the first array would then occur not only when the incident light is perpendicular to the first direction but also when parallel to the first direction (i.e. perpendicular to the secondary axis which here is at 90 degrees to the primary axis). In the case of a footprint which is a regular hexagon, illumination by the first array would occur when the incident light is perpendicular to the first direction and also when at 30 and 60 degrees thereto.

Nonetheless, in most preferred implementations, the anisotropic light redirecting elements are each elongate along their primary axis. Here, the elements could still have secondary axes but the optical effect thereof will be diminished since fewer faces parallel to the secondary axes will be present per unit area as compared with the number of faces parallel to the primary axes.

As noted above, opposing faces of the elements could be differently shaped but preferably, the anisotropic light redirecting elements are each substantially symmetrical about their primary axis. In this way the opposing faces of each element will reinforce the illumination effect of the other.

The anisotropic light redirecting elements of the first array should preferably be substantially identical to one another, i.e. have the same light re-directing characteristics. However, it will be appreciated that at the perimeter of the first region, the elements will curtailed and so their footprint (length, for instance), may vary from one element to another.

The anisotropic light redirecting elements are each preferably smaller than the width of the stripes in the colour layer, in order that each element will illuminate only a single colour. Thus, in preferred embodiments, the anisotropic light redirecting elements have a width between 10 and 40 microns.

In preferred implementations, the anisotropic light redirecting elements are prisms extending along their primary axis and preferably having a cross-section which is a triangle, a trapezium, an arch, a circular segment or an elliptical segment. In such cases, the elements will have no secondary axis and so the first array will only illuminate the first image when the incident light is perpendicular to the first direction. In alternative preferred embodiments, the anisotropic light redirecting elements may be pyramids (truncated or not truncated) with straight-edged bases—e.g. triangular, square, rectangular or hexagonal bases. In this case the elements have a primary axis plus at least one secondary axis (one in the case of square and rectangular pyramids, and more in the case of triangular and hexagonal pyramids). It should be noted that in all cases, the shapes mentioned need not be regular versions of those shapes. For example, prisms with an irregular triangle cross-section could be used, such as may form a sawtooth structure in combination. Further, the faces of the elements may not be perfectly flat or may not follow a precise curve, depending on the manufacturing process used. For instance, if the elements are formed by printing, while overall their surface will follow the preferences indicated above, on a smaller scale it may be somewhat irregular.

In some preferred implementations, the anisotropic light redirecting elements are substantially transparent and have a refractive index different from any material in contact with an optically active surface of the elements. Elements such as these can be used to form devices suitable for viewing in transmitted and/or in reflected light. The optically active surface is that (or those) which causes the light to be redirected and hence in the above-mentioned preferred embodiments will include the described flat or curved faces of the elements. Depending on the construction of the device this surface might be exposed to air (in which case the elements will automatically have a different refractive index) or may be in contact with another material, such as a protective coating, in which case it is necessary to ensure that the refractive indexes are sufficiently different so as not to “index out” the elements. For instance, a refractive index difference of at least 0.3 is preferred.

In addition or as an alternative, at least an optically active surface of the anisotropic light redirecting elements may be reflective. For instance, a reflection enhancing material may be applied to the optically active surface (or parts thereof), such as a metal, metal alloy, metallic ink or high refractive index material (e.g. ZnS). If the reflective material is opaque this will prevent the device operating in transmitted light, but alternatively the reflective material may be semi-transparent (e.g. a very thin or discontinuous metal or alloy layer), or even transparent (e.g. ZnS).

As mentioned above, the lateral extent of the first region is configured to represent a first image. In preferred implementations, each location of the first region, corresponding to a respective pixel of the first image, comprises one or more illumination zones arranged in sectors, one for each of the colours of the colour layer, along the direction of colour periodicity, the extent of the illumination zone(s) within each sector being configured such that, when illuminated by the first region, the area of the colour layer overlapping the location displays the colour of the respective pixel of the first image. The manner in which this is achieved will be explained in more detail below. In each location, the first region may comprise only a single illumination zone or multiple illumination zones and these may or may not be spaced from one another in the direction of colour periodicity, depending on the desired colour and hence the size of those zones. Within each location, the illumination zone(s) preferably extend all the way in the direction orthogonal to the direction of colour periodicity such that, in combination, the illumination zones from all of the locations combine to form lines of varying width, making up the first region, the lines extending in the direction orthogonal to the direction of colour periodicity and aligning with the strips of the colour layer.

The optical device described so far exhibits a single image (the first image) which appears to turn “on” and “off” upon changing the illumination angle, e.g. by rotating the device as described above. If the area of the light redirecting layer outside the first region is void of functioning light redirecting elements, no illumination will be seen when the incident light is not perpendicular to the first direction. Alternatively, the entire area outside the first region could be filled-in with another array of light redirecting elements having their primary axis orientated at a different angle, e.g. orthogonal to the first direction. In this way when the device is rotated, the first image will also be displayed at additional angles, but with its colour reversed (i.e. a “negative” version of the first image).

In still further, and especially preferred, embodiments, the optical device could be adapted to display more than one image sequentially, as the illumination angle is changed. This is particularly advantageous since the plurality of images can each be different, allowing for the device to exhibit animation effects of the sort also achievable in lenticular devices. However, as described above, unlike a lenticular device, these effects will be revealed by rotating the optical device relative to the light source rather than by tilting the device to change the viewing angle.

Hence, preferably, the light redirecting layer defines a plurality of images to be exhibited by the optical device, including the first image, the light redirecting layer comprising a corresponding plurality of arrays of refractive and/or reflective anisotropic light redirecting elements, each array extending across a respective region of the light redirecting layer and being absent elsewhere, the anisotropic light redirecting elements of each respective array all having a primary axis orientated along a direction lying in the plane of the optical device, which direction is different for each array, the anisotropic light redirecting elements of each respective array being configured such that an incident light beam lying in a plane perpendicular to the primary axis direction and from a light source off the normal of the optical device will be redirected by the anisotropic light redirecting elements towards the normal of the optical device but within the same plane, whereas an incident light beam lying in a plane which is not perpendicular to the primary axis direction and from a light source off the normal of the optical device will either not be redirected, or will be redirected by the anisotropic light redirecting elements out of the plane of the incident light beam. Each respective region is arranged such that, at each location across the region, the relative proportions of the at least two different colours of the colour layer which are illuminated by the anisotropic light redirecting elements are configured to exhibit in combination a colour of a corresponding pixel of the respective image. As a result, for a viewer substantially on the normal of the optical device, when the angle of the incident light beam from a light source off the normal of the optical device is changed, colour versions of each of the plurality of image will be exhibited sequentially by the device.

It will be appreciated that each of the regions will be laterally offset from one another in the sense that they do not overlap one another, so that the light redirecting elements in any one region all have the same orientation. However as described below this can be achieved in various ways, including interlacing the regions so that they appear to occupy the same area of the device. The light redirecting elements in each region can have any of the forms already discussed above in relation to the first region, and the form of the elements could be the same in each region or could be different. For example, the first array in the first region could comprise elements in the form of triangular prisms, while the second array in the second region could comprise elements in the form of hemispherical prisms. What is important is that the primary axis of the elements in one region is differently orientated (in the plane of the device) relative to the primary axis of the elements in the other region(s). If one or more of the arrays comprises elements also having secondary axes (e.g. pyramidal elements), the various arrays should be configured so that the primary axis of each array also makes a non-zero angle with the secondary axis direction of each other array. In this way, each region will illuminate a corresponding (overlapping) part of the colour layer at a different illumination angle. As in the case of the first region, each additional region is configured to represent a corresponding additional image so that the part of the colour layer illuminated by each region exhibits a colour version of the respective image. Again, this may be a single-coloured or multi-coloured image, depending on the nature of each source image.

The various arrays of light redirecting elements could have their respective primary axes making any non-zero angle with those of the other arrays. However, it is preferred that the different directions in which the primary axes of the respective arrays of anisotropic light redirecting elements lie are approximately equally angularly spaced from one another in the plane of the device. In this way, when the device is rotated in use, each image will be illuminated after an approximately equal amount of rotation. For instance, in a device configured to exhibit two images, the first and second directions may be orthogonal to one another, whereas in a device configured to exhibit three images, the first, second and third directions may be separated from the next by 45 degrees.

The regions could each occupy separate areas of the device, so that the respective images are exhibited at different positions across the device. For instance, the regions could abut one another, surround one another, or be spaced from one another. However, as mentioned above, in preferred embodiments, the regions are interlaced with one another so as to give the impression that the images are located in the same area of the device. This can be achieved by configuring each of the plurality of regions to have the form of a set of elongate slices aligned substantially parallel to the direction of colour periodicity and arranging the sets of elongate slices to be interlaced with one another in the direction orthogonal to the direction of colour periodicity, whereby the plurality of images are located in the same area of the optical device as one another. This interlacing of the regions can be achieved using much the same methods as those by which multiple images are interlaced in conventional, lenticular devices.

By arranging the elongate slices of the regions to extend along the direction of colour periodicity, whilst the elongate colour strips of the colour layer extend along the orthogonal direction (both the slices and the strips preferably being substantially rectilinear), all of the colour strips run across all of the slices of the regions. This ensures that all of the at least two colours of the colour layer are available for display in each slice and hence each of the images can be displayed as a multi-coloured image if desired. If the colour strips had some other arrangement, it would be necessary to form them at high resolution to ensure that each colour was available to each region slice to enable this. This would require the colour layer to be formed at a similar level of resolution as the light redirection layer which is extremely difficult in multiple colours due to the high registration that would be required. However by arranging the colour layer as specified above, there is no such restriction. The colour strips only need be arranged at a sufficiently small pitch that the individual colours are combined by the naked human eye (i.e. without magnification), which will typically be the case for strip widths of around 200 microns or less, more preferably 100 microns or less. Hence any standard printing process (or other image formation method) can be used to form the colour layer, including digital methods such as inkjet or laser printing, as well as techniques such as gravure printing, lithographic printing, flexographic printing, intaglio printing, offset printing, screen printing and the like.

The various images could take any desired form, and could be related or unrelated to one another. For example, a first image could comprise a currency identifier (e.g. “£”, “$” etc.) while a second image could comprise a denomination value (e.g. “10” or “TEN”). In this case the device would appear to switch between one image and the other upon rotating relative to the light source.

However in particularly preferred embodiments, the plurality of images are configured to display when viewed in sequence an animation, movement, morphing, three-dimensional, enlarging or contracting effect. Examples will be given below. Still more advantageous is where the effect displayed by the plurality of images when viewed in sequence is cyclic. That is, the frames (images) making up the animation or other effect form a closed loop of images so when the device is rotated relative to the light source a continuous effect is exhibited, with no significant “jump” in the appearance of the device between viewing the last image in the sequence and viewing the first image again, on continued rotation. Examples of suitable cyclic image sequences are disclosed, in the context of lenticular devices, in WO2012/153106.

As noted above, the colour versions of each image may individually be single-coloured or multi-coloured. This will depend on the source image(s). A multi-coloured image is one which contains at least two colours, preferably more. It should be noted that the device does not require any of the individual images themselves to be multi-coloured and this is because the technique works equally well where one or more—or each—of the images is individually monochromatic. However, preferably, where there is more than one image, the at least two images collectively include parts in at least two different colours so that the device as a whole is multi-coloured. Thus in an exemplary “two-channel” device, the first image could be monochromatic red for instance and the second image monochromatic blue for example. A monochromatic source image will result in a monochromatic output image (for that channel), whereas a multi-coloured source image will result in a multi-coloured output image (for that channel). It is also desirable that at least the first image is a multi-coloured image, and where there are multiple images, that some or all of the images are multi-coloured. This results in a device with greater visual impact, which is more difficult to imitate.

The content of each image can be take any form depending on the desired design and could be as basic or as complex as desired, including photographic type images. In preferred cases, at least the first image comprises one of a letter, number, symbol, character, logo, portrait or graphic. Advantageously, where there are multiple images, some or all of the images comprise one or more thereof.

The colour layer could include any number of different coloured strips provided there are at least two different colours. However in order to achieve full colour versions of the images, it is particularly advantageous if the colour layer comprises elongate strips of at least three, preferably exactly three or exactly four, different colours which alternate with one another periodically in the direction of colour periodicity, the colours preferably being red, green and blue, or cyan, magenta, yellow and black. In this way, substantially any colour can be created by mixing the available colours in appropriate proportions. It should be noted that, throughout this disclosure, the term “colour” encompasses all visible hues including achromatics such as white, grey, black, silver etc., as well as chromatic colours such as red, orange, yellow etc.

As mentioned above, the colour strips do not need to be formed at particularly high resolution but it is preferred that they are sufficiently narrow that the naked human eye cannot easily distinguish between them. In preferred examples, the elongate strips of the colour layer each have a width in the direction of colour periodicity of between 20 and 200 microns, preferably between 50 and 150 microns, more preferably between 75 and 125 microns.

It is strongly preferred that the colour layer and the light-redirecting layer are registered to one another at least in terms of skew in order that the first region of the light redirecting layer aligns with the strips of the colour layer accurately. In contrast, registration between the colour layer and the light-redirecting layer in terms of translational position along the direction of colour periodicity is not essential but is preferred in order to achieve true colour versions of the original images. Registration in the orthogonal direction is not required between the colour layer and the light-redirecting layer due to the arrangement of the colour strips being substantially invariant in this dimension.

The optical device is preferably a security device but could alternatively be configured for use in other fields, such as decorative uses e.g. on packaging or advertising.

The invention further provides a security article comprising an optical device as described above, wherein the security article is preferably formed as a security thread, strip, foil, insert, label or patch.

Also provided is a security document comprising an optical device or a security article each as described above. Preferably, the security document is formed as a banknote, cheque, passport, identity card, certificate of authenticity, fiscal stamp or another document for securing value or personal identity. In particularly preferred embodiments, the security document comprises a substrate with a transparent window portion and the optical device is located at least partially within the transparent window portion. For instance, the security document could comprise a translucent or opaque document substrate, made for example of paper or a paper/polymer multilayer construction, and include a window region in which the substrate is absent so as to reveal therein a security article such as a thread or strip on which the optical device is carried. Alternatively, the security document could comprise a transparent document substrate, e.g. a polymer banknote or a plastic ID document such as a passport, a portion of which is left substantially uncovered by opacifying materials to form a window region. In this case the optical device could be formed directly on the transparent document substrate.

Also disclosed is a method of manufacturing an optical device, comprising:

(a) providing a colour layer which comprises elongate strips of at least two different colours alternating with one another periodically along a direction of colour periodicity, the elongate strips extending along the direction which is orthogonal to the direction of colour periodicity;
(b) generating a template for a light redirecting layer, which template defines at least a first region thereof, corresponding to a first image to be exhibited by the optical device, by:
(b1) providing a version of the first image comprising a plurality of image pixels, each image pixel exhibiting a uniform colour;
(b2) for each image pixel of the first image, creating a corresponding template pixel based on the colour of the respective image pixel, each template pixel comprising an arrangement of one or more illumination zones and/or one or more non-illumination zones, different arrangements of the of one or more illumination zones and/or one or more non-illumination zones in different ones of the template pixels defining different respective colours;
(b3) arranging the template pixels in accordance with the positions of their corresponding image pixels in the first image to form the template for the light receiving layer, the illumination zones of the template pixels in combination forming the first region thereof which defines the first image;
   (c) forming a light redirecting layer in accordance with the generated template, the light redirecting layer comprising at least a first array of refractive and/or reflective anisotropic light redirecting elements extending across a first region of the light redirecting layer corresponding to the first region of the template and being absent elsewhere, the anisotropic light redirecting elements of the first array each having a primary axis orientated along a first direction lying in the plane of the optical device and being configured such that an incident light beam lying in a plane perpendicular to the first direction and from a light source off the normal of the optical device will be redirected by the anisotropic light redirecting elements towards the normal of the optical device but within the same plane, whereas an incident light beam lying in a plane which is not perpendicular to the first direction and from a light source off the normal of the optical device will either not be redirected, or will be redirected by the anisotropic light redirecting elements out of the plane of the incident light beam; and
   (d) overlapping the colour layer and the light redirecting layer to form the optical device;
whereby for a viewer substantially on the normal of the optical device, when the incident light beam lies in a plane perpendicular to the first direction and is from a light source off the normal of the optical device, portions of the colour layer which overlap the first region of the light redirecting layer are illuminated by the anisotropic light redirecting elements relative to the remainder of the colour layer, such that for a viewer substantially on the normal of the optical device, when the incident light beam lies in a plane perpendicular to the first direction and is from a light source off the normal of the optical device, a colour version of the first image will be exhibited by the device.

Thus the method results in an optical device of the sort already described above, and having the attendant benefits thereof. It should be appreciated that while steps (b1), (b2) and (b3) must be performed in that order, and step (b) must be performed before step (c), otherwise the order of steps is not essential. For instance, step (a) could be performed before, during or after steps (b) and (c). Step (d), in which the colour layer and light redirecting layer are overlapped, may be a distinct step or may occur automatically during the provision of either layer. For example, the colour layer could be formed by printing it onto a substrate which already carries the light redirecting layer, in which case this action will automatically result in the required overlapping.

Steps (b1), (b2) and (b3) result in a template for the first region which is based on the first image to be displayed by the device, and hence ensure that, at each location across the first region, the relative proportions of the at least two different colours of the colour layer which will be illuminated by the light redirecting layer formed in step (c) will exhibit in combination a colour of a corresponding pixel of the first image.

The arrangement of the illumination and/or non-illumination zone(s) in each template pixel depends on the colour of the image pixel to which it corresponds in the original image. Thus, if there are two or more template pixels deriving from image pixels which were of the same colour in the original image, those template pixels will be allocated the same arrangement of illumination and/or non-illumination zone(s), or at least arrangements with the same proportion of each colour illuminated, so that the end appearance is the same. On the other hand, template pixels deriving from image pixels which were of different colours in the original image will have different arrangements of illumination and/or non-illumination zone(s). It should be appreciated that some template pixels could comprise solely a (single) non-illumination zone which extends across the whole area of the pixel, for instance if the colour of that pixel is to be black. Similarly, some template pixels could comprise solely a (single) illumination zone extending across the whole pixel area, for instance if all of the colours of the colour layer are required, in the same relative proportion as arranged on the colour layer, to produce the desired colour (e.g. white, if the colours of the colour layer are red, green and blue). However, typically at least some (and usually most, where the image is multi-coloured) of the template pixels will each contain at least one illumination zone and at least one non-illumination zone such that the resulting light redirection layer will illuminate only part of the colour layer in that area.

It should also be noted that while the version of the at least one image that is displayed by the optical device will be coloured to the same extent that the original image was coloured, the colour(s) themselves may or may not the same as that or those in the original image. That is, the version of the first image ultimately displayed may be a “false colour” version of the original source image, e.g. swapping each colour in the original image with another. This is because it is not essential to register the light redirection layer with the colour layer longitudinally along the direction of colour periodicity, and hence if there is lateral displacement different portions of the colour stripes will be illuminated by the light redirection layer, and the particular colours seen will depend on the degree of mis-register. Only if lateral registration is applied will each part of the light redirection layer corresponding to a particular template pixel line up as intended with the colour strips and therefore generate the original colours (or a near approximation thereof). Whilst this will be the preference in many cases, in other embodiments a false colour image may be acceptable (e.g. if the image does not depict something with an expected colour—for instance text against a plain background will appear appropriate in any colour whereas an image of a tree will be expected to be green and brown), and may indeed be preferred. A false colour version of the image may also be generated in certain configurations where light pass through the colour layer twice before reaching the observer (e.g. some reflective configurations).

Typically, method step (b) will be performed using one or more appropriately programmed processors whilst steps (a), (c) and (d) will involve the use of appropriate output means for physically forming and overlapping the colour layer and light redirection layer, such as printing facilities or the like.

In step (b1), the version of the first image provided could already be formed as an array of pixels of the desired size. However, in other cases the method may include an additional preliminary step of creating this version of the first image from some original input (source) image. This could for example be a bitmap, jpeg or any other image format and may already be formed of pixel-type elements although these may not be of the desired resolution. For instance, the original image may have pixels at a higher resolution (i.e. smaller size) than it is desired to replicate in the optical device. Hence in preferred examples, step (b1) comprises providing a source version of the first image and converting it to the desired version of the first image by dividing the source version into a grid of pixels of predetermined size and allocating each pixel a single colour based on the original colour(s) of the respective portion of the image. Thus if for example the original source image is formed of pixels at a resolution four times that desired in the optical device, the conversion may involve averaging the colour of each set of four adjacent pixels to produce one new pixel at the desired size. Preferably, all of the pixels of any one image are of the same size and shape, which will typically be square or rectangular. The pixels should preferably be sufficiently small that the naked human eye sees a substantially continuous image and not the individual pixels. In preferred embodiments the pixels have a size of between 50 and 500 microns, preferably between 100 and 300 microns.

The template pixels can be created in a number of different ways. In a first preferred implementation, in step (b2) each template pixel is created by identifying the colour of the respective image pixel and using a look-up table stored in memory to select an arrangement of one or more illumination zones and/or one or more non-illumination zones corresponding to the identified colour. Hence, prior to performing the method, the look-up table must be populated with a set of possible colours for the image pixels and a corresponding arrangement of illumination and/or non-illumination zones for each one. In this case there will be a finite number of possible colours stored and so in practice it will be necessary to approximate the identified colour to the closet available colour in the look-up table. This could be done for example by associating each colour in the look-up table with a range of colour values (preferably centred on the stored colour itself) and then selecting which of the stored colours (and hence template arrangements) should be used for any one image pixel by selected the stored colour having a colour range into which the identified colour of the image pixel falls.

In an alternative preferred implementation, in step (b2) each template pixel is created by identifying the colour of the respective image pixel, identifying what relative proportions of the at least two colours of the colour layer are required to form the identified colour, and using an algorithm to generate an arrangement of one or more illumination zones and/or one or more non-illumination zones which will light-up the identified relative proportions of the at least two colours of the colour layer. This approach has the advantage that there is no limit placed on the number of different colours which can be represented in the template image. However, it is also more computationally expensive.

The arrangement of illumination and/or non-illumination zones in each template pixel could take any desirable form, including a half tone pattern or the like. However, in particularly preferred implementations, each template pixel is divided in the direction of colour periodicity into at least two sectors, one for each of the at least two different colours of the colour layer, and the one or more illumination zones and/or one or more non-illumination zones of each template pixel are arranged in one or more of the sectors with the relative proportions thereof being based on the colour of the corresponding pixel of the first image. It will be appreciated that this alignment between the sectors and the direction of colour periodicity cannot be realised until the light redirecting layer is formed and overlapped with the colour layer, but the template pixels should be designed to enable it. Within each sector, the proportion of the template pixel filled by an illumination zone could be anywhere between 0 and 100%, depending on the desired colour. Preferably, in step (b2), the illumination and/or non-illumination zones forming each mask pixel each extend in the direction orthogonal to the direction of colour periodicity from one side of the template pixel to the other, the width and position of the illumination zones in the direction of colour periodicity determining the colour that will be exhibited by the portion of the optical device corresponding to the template pixel, when it is combined with the colour layer. In this way the illumination zones of all the template pixels combine to form lines extending in the direction orthogonal to the direction of colour periodicity, which make up the first region.

The light redirecting layer could be formed using any method which achieves the required resolution. In preferred embodiments, in step (c), the light redirecting layer is formed by printing, embossing, stamping or cast-curing the first array of anisotropic light receiving elements onto a substrate only within the first region. Thus, the elements of the first array are selectively applied within the first region and not elsewhere. Suitable printing methods include intaglio printing or screen printing the elements, optionally using reticulation methods such as those described in WO-A-2013/167887. As mentioned above, forming the elements by printing may result in their surfaces being somewhat irregular, but good results can still be achieved. Nonetheless, embossing or cast-curing methods are preferred in order to form the elements more precisely. Embossing typically involves stamping a die carrying the desired surface relief structure (defining the elements) in its surface into a material suitable for use as the elements, such as a thermoplastic polymer. Optionally this may be carried out at an increased temperature to promote forming of the material. Cast curing involves applying a curable material, such as a UV curable material, either to a substrate which is then brought into contact with a die carrying the desired surface relief, or directly to such a die which is then brought into contact with a substrate, and at least partially curing the material while it is in contact with the die. The substrate is then separated from the die with the formed material affixed thereto, and optionally cured further if necessary. In preferred embodiments the embossing or cast-cure die may constitute the surface of a roller (or a sheet conforming to the surface of a roller), to enable continuous production of the said light redirecting layer.

In other embodiments, the light redirecting layer may be formed by providing a substrate carrying the first array of anisotropic light receiving elements over an area greater than that of the first region, and then disabling (substantially all of) the anisotropic light redirecting elements outside the first region. The elements may be provided on the substrate by any available method, including printing, embossing or cast-curing as described above. Formation of the elements could be carried out as part of the disclosed method or alternatively the substrate could be supplied with a pre-formed array of elements thereon. Disabling the anisotropic light redirecting elements means rendering them non-functional such that they do not act on incident light in the manner described above. This can be achieved in a number of ways. For instance, in one preferred implementation, the anisotropic light receiving elements outside the first region are disabled by applying a material of substantially the same refractive index as that of the anisotropic light receiving elements on to the anisotropic light receiving elements outside the first region. In other words, the elements are “indexed-out”. In another preferred implementation, the anisotropic light receiving elements outside the first region are disabled by modifying or obliterating the anisotropic light receiving elements, preferably by heating, stamping, laser irradiation or any combination thereof. This may involve reshaping the optically active surface(s) of the elements so that they no longer function as intended, or destroying the elements entirely.

The method described so far will result in an optical device displaying a single image. However as already discussed, in particularly preferred embodiments the device is configured to display more than one image in dependence on the illumination angle. Hence, preferably, the template for the light redirecting layer generated in step (b) defines a plurality of regions thereof, including the first region, each of the regions corresponding to a respective image to be exhibited by the optical device, the template being generated by repeating steps (b1), (b2) and (b3) for each respective image. It should be noted that the repetition of these steps could be in sequence or in parallel. That is, each image could be processed to form a corresponding region one at a time in sequence, or more than one could be processed simultaneously, depending on the resources available.

The light redirecting layer formed in step (c) then comprises a corresponding plurality of arrays of refractive and/or reflective anisotropic light redirecting elements, each array extending across a respective region of the light redirecting layer and being absent elsewhere, the anisotropic light redirecting elements of each respective array all having a primary axis orientated along a direction lying in the plane of the optical device, which direction is different for each array, the anisotropic light redirecting elements of each respective array being configured such that an incident light beam lying in a plane perpendicular to the primary axis direction and from a light source off the normal of the optical device will be redirected by the anisotropic light redirecting elements towards the normal of the optical device but within the same plane, whereas an incident light beam lying in a plane which is not perpendicular to the primary axis direction and from a light source off the normal of the optical device will either not be redirected, or will be redirected by the anisotropic light redirecting elements out of the plane of the incident light beam. As a result, for a viewer substantially on the normal of the optical device, when the angle of the incident light beam from a light source off the normal of the optical device is changed, colour versions of each of the plurality of images will be exhibited sequentially by the device.

As previously mentioned, it is desirable that the different images are displayed by the device at approximately equal angular intervals as it is rotated relative to the illumination source. Hence, in step (c) the different directions in which the primary axes of the respective arrays of anisotropic light redirecting elements lie are preferably approximately equally angularly spaced from one another in the plane of the device.

The various regions could be located in different respective areas of the device so that the images are displayed in different positions from one another. However, as mentioned above it is preferred that the images appear to occupy the same area of the device. As such, in preferred implementations, step (b) further comprises, after performing step (b3) for each of the images:
(b4) interlacing the plurality of regions by selecting a set of elongate slices aligned substantially parallel to the direction of colour periodicity from each of the regions and interlacing the sets of elongate slices with one another in the direction orthogonal to the direction of colour periodicity that the plurality of regions are located in the same area of the template as one another.

The elongate slices taken from each region should preferably be of a width and spacing which results in the human eye perceiving the set of slices as a continuous whole when they are illuminated, so that the corresponding image appears complete. As such the width and spacing of the slices should be smaller than the naked human eye can distinguish between under normal viewing conditions. Therefore, in step (b4) the elongate slices into which each region is divided advantageously have a width of between 1 and 100 microns, preferably between 1 and 50 microns, more preferably between 10 and 30 microns.

The interlacing performed on the two or more regions in step (b4) can be implemented using any conventional image interlacing process, such as any of those disclosed (in the context of lenticular devices) in U.S. Pat. No. 4,892,336, WO-A-2011/051669, WO-A-2011051670, WO-A-2012/027779 or U.S. Pat. No. 6,856,462. The non-selected elongate slices from each region which are not used in to form the interlaced set of regions will be discarded. In preferred embodiments, selecting a subset of elongate slices from each region comprises selecting every n^{th} elongate slice from each region, where n is an integer greater than 1. Typically the value of n will correspond to the number of channels (and hence images) to be displaced in the finished optical device. For instance, in a 2-channel device, every second slice from each region will typically be selected, whereas in a 3-channel device it will be every third slice, and so on.

The light redirecting layer could be formed using any of the above-described methods to produce each of the arrays of elements. For example, each array could be applied to its respective region of a substrate sequentially, by printing multiple workings one after the other (preferably in an in-line process). However, for optimum registration between the arrays, it is preferred that step (c) comprises forming a production tool defining each of the plurality of arrays of anisotropic light redirecting elements in a surface thereof, each array extending across a respective region in accordance with the template generated in step (b), and then using the production tool to form the light redirecting layer, whereby the plurality of arrays of anisotropic light redirecting elements are formed simultaneously. The production tool may be, for example, a die suitable for use in an embossing, stamping or cast-cure process such as those described above, the multiple regions of elements being formed therein as a surface relief. This can be implemented, for instance, by etching or engraving the surface of a suitable die. In preferred embodiments the die constitutes the surface of a roller (or a sheet conforming to the surface of a roller), to enable continuous production of the said light redirecting layer.

As indicated above, the colour layer need not be formed using a high resolution technique provided the colour strips are sufficiently narrow that they cannot be individually resolved by the naked human eye. In preferred implementations, the colour layer is formed by printing, more preferably by gravure printing, screen printing, offset printing, lithographic printing, intaglio printing or a digital printing technique such as laser printing or inkjet printing.

Advantageously, the colour layer and the light-redirecting layer are registered to one another at least in terms of skew and preferably also translational position along the direction of colour periodicity. That is, steps (a) and (c) are registered to one another, and may preferably be performed in one in-line process. Alternatively a pre-processed substrate carrying the colour layer may be supplied and the remaining steps performed thereon.

The method can be further adapted to providing the optical device with the any of the preferred features mentioned above. Again, preferably, the manufactured optical device is a security device.

Examples of optical devices and methods of their manufacture will now be described with reference to the accompanying drawings, in which:

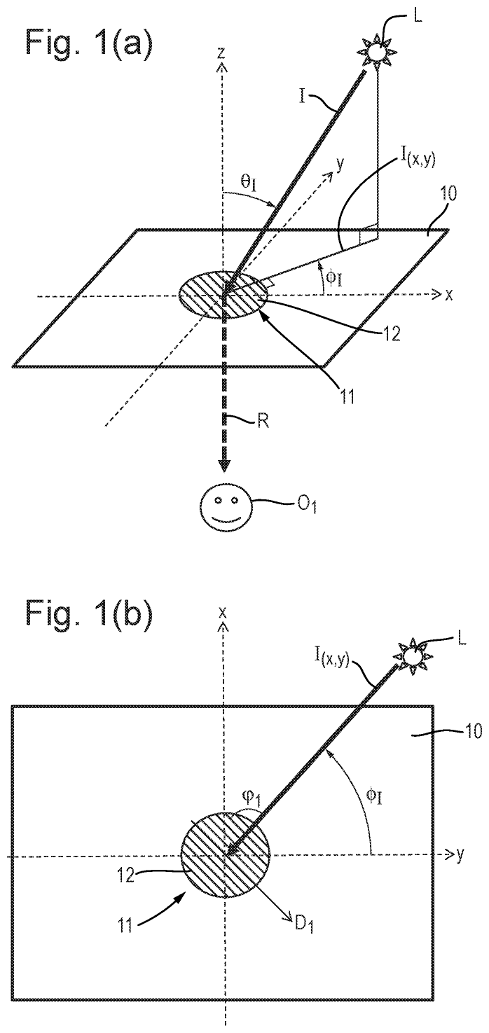

FIG. 1 schematically illustrates an exemplary light redirection layer of an optical device in accordance with an embodiment of the invention, in (a) perspective view and (b) plan view, in order to illustrate conventions regarding orientation and notation that will be adopted in the ensuing description;

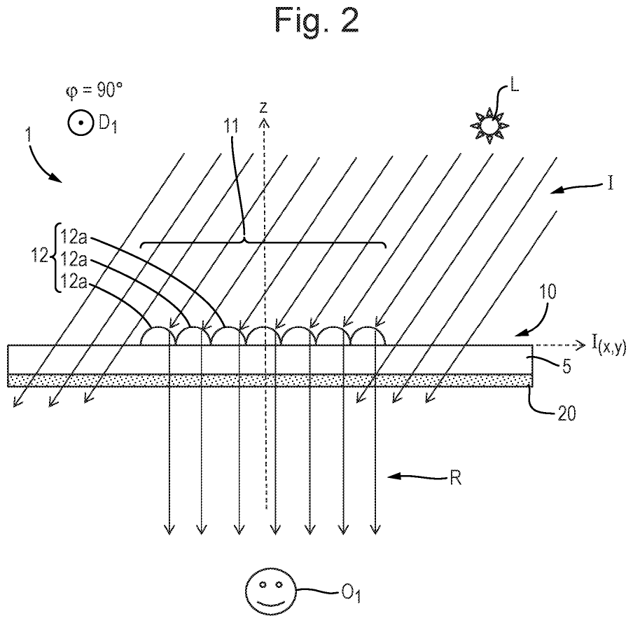

FIG. 2 shows a cross-section through a first embodiment of an optical device, along a plane containing the incident light beam;

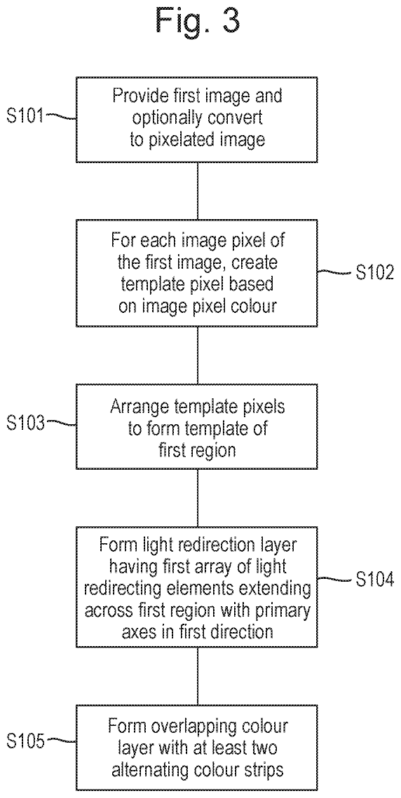

FIG. 3 is a flow diagram illustrating selected steps of an exemplary method for manufacturing an optical device;

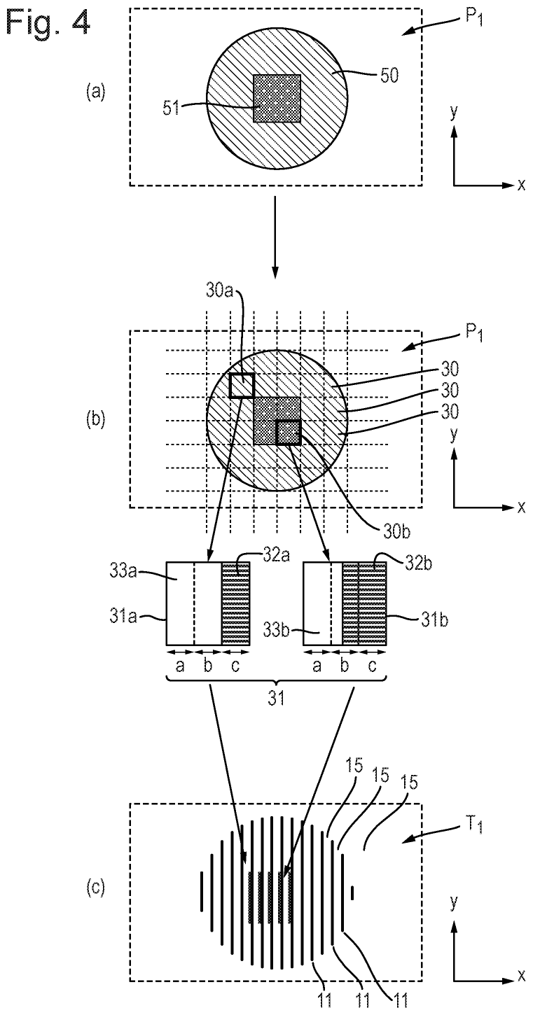

FIGS. 4(a), (b) and (c) illustrate selected steps of the method of FIG. 3 for an exemplary optical device;

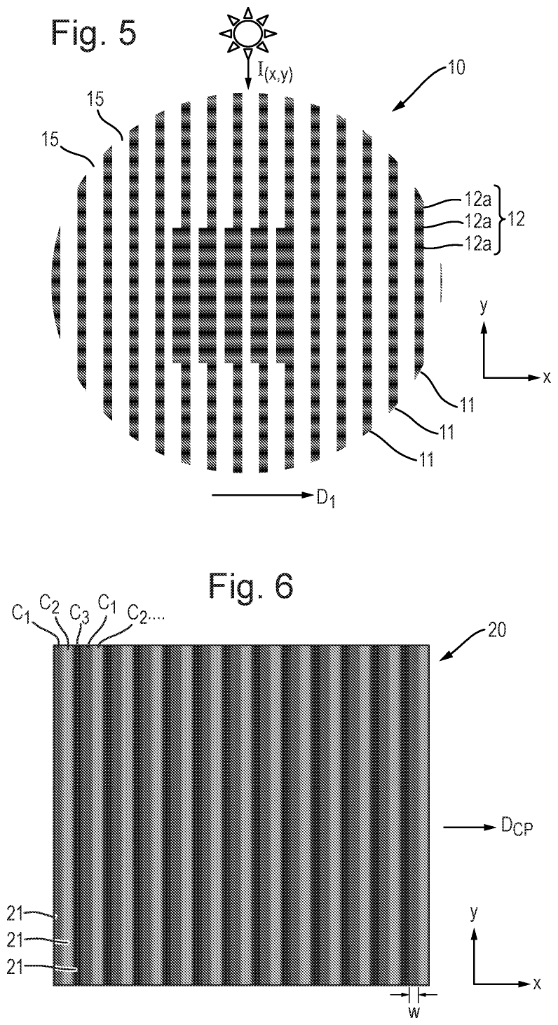

FIG. 5 shows an exemplary light redirection layer formed in accordance with the method of FIG. 3, in plan view;

FIG. 6 shows an exemplary colour layer as may be used in the method of FIG. 3, in plan view;

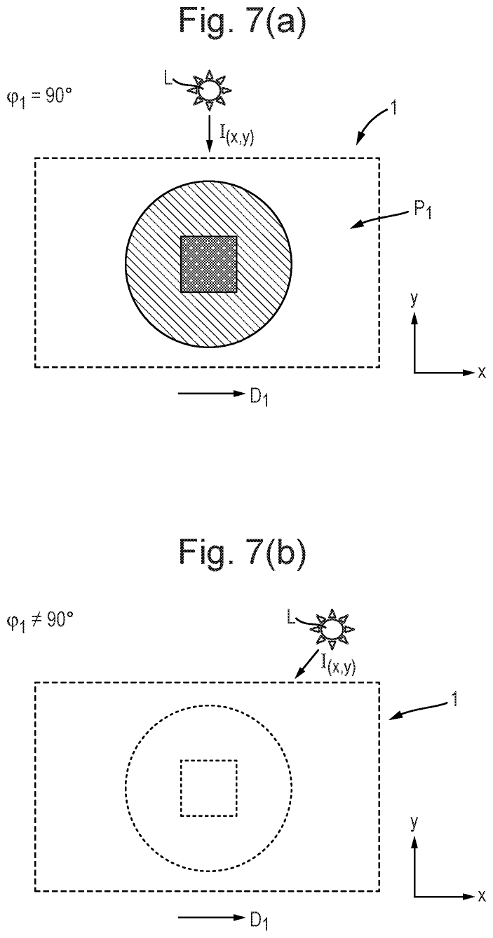

FIGS. 7(a) and (b) illustrate the appearance of an exemplary optical device formed in accordance with the method of FIG. 3, in plan view, at two different illumination angles;

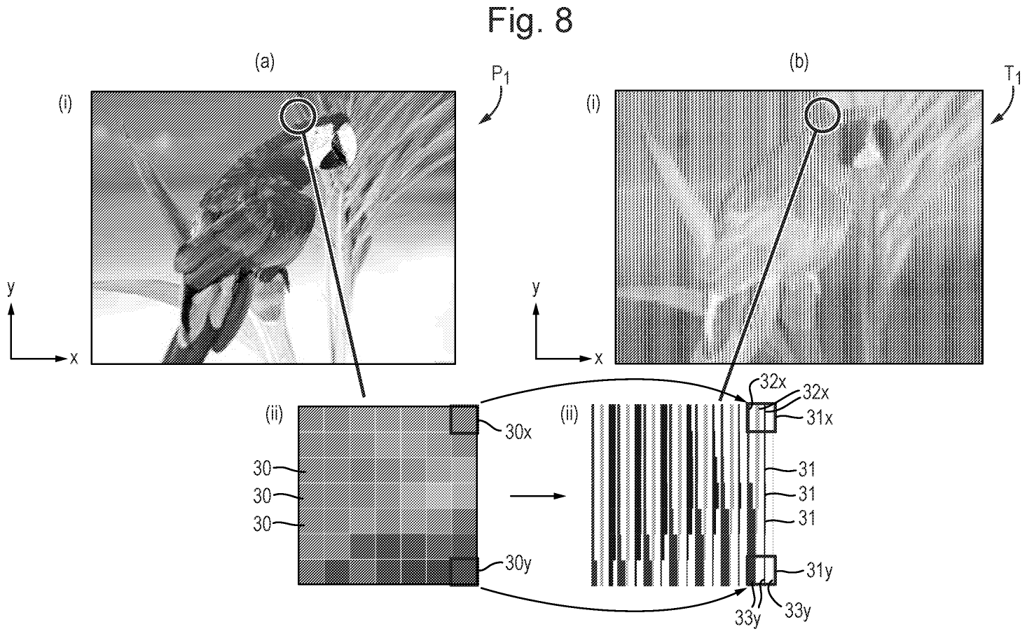

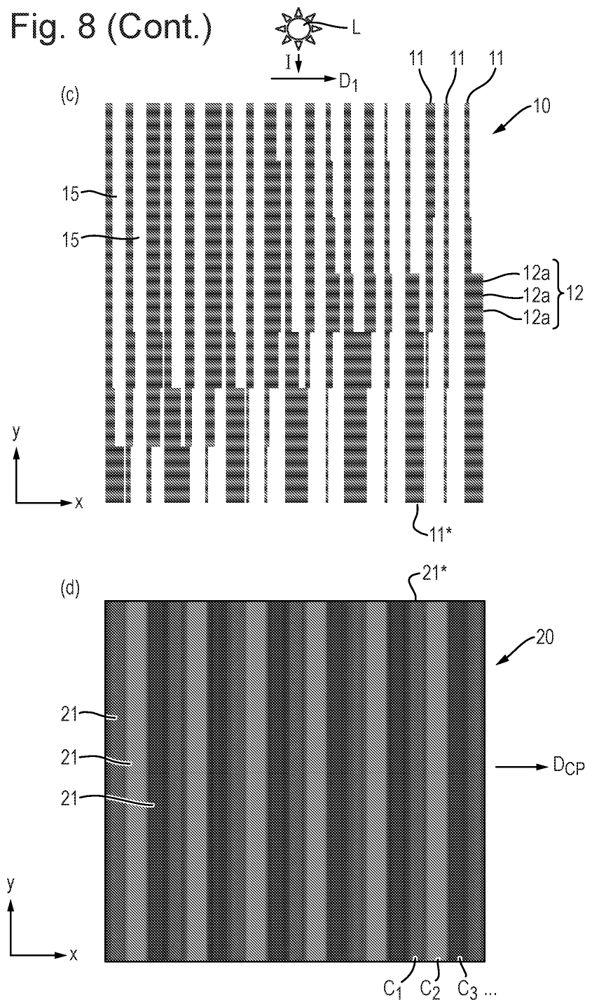

FIG. 8 illustrates selected steps involved in the making of another embodiment of an optical device, FIG. 8(a)(i) showing a first image and (ii) an enlarged portion thereof; FIG. 8(b)(i) showing a first template formed based on the first image and (ii) an enlarged portion thereof; FIG. 8(c) showing a portion of a light redirection layer formed in accordance with the first template; and FIG. 8(d) showing a portion of a colour layer, all in plan view;

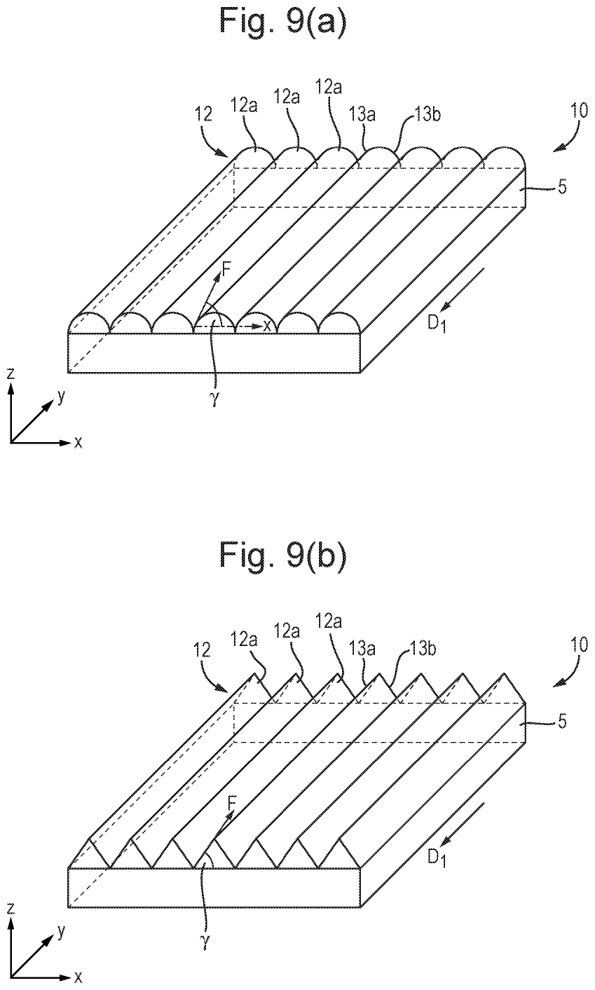

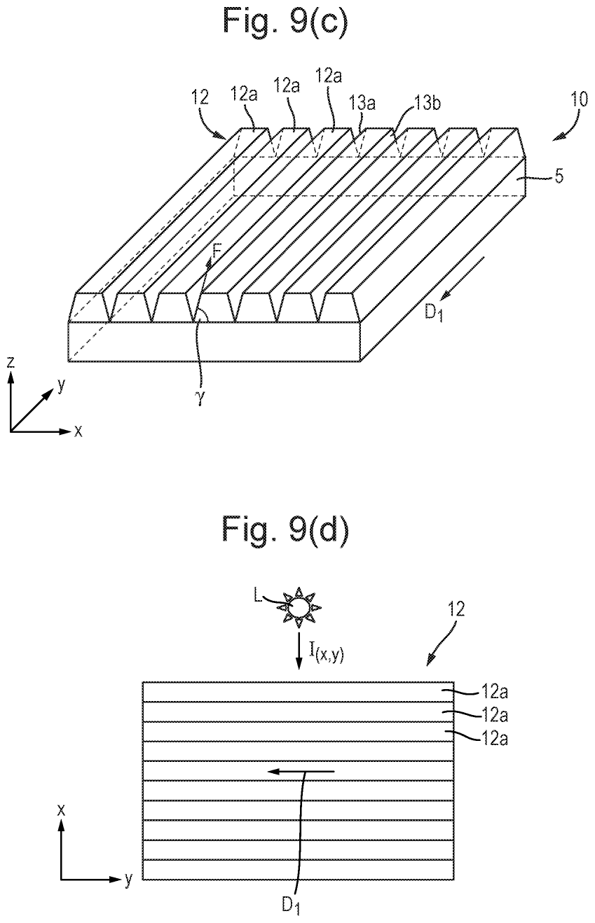

FIGS. 9(a), (b) and (c) schematically illustrate portions of three exemplary arrays of light redirecting elements as may be used in embodiments of optical devices, in perspective view, FIG. 9(d) showing the schematic appearance of all three exemplary arrays in plan view;

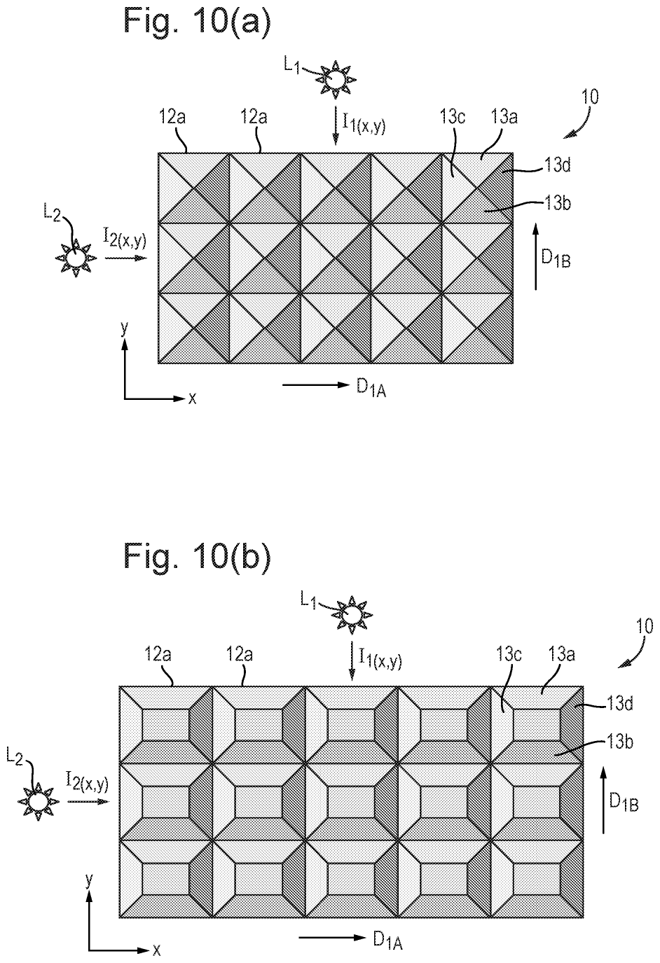

FIGS. 10(a) and (b) schematically illustrate portions of two further exemplary arrays of light redirecting elements as may be used in embodiments of optical devices, in plan view;

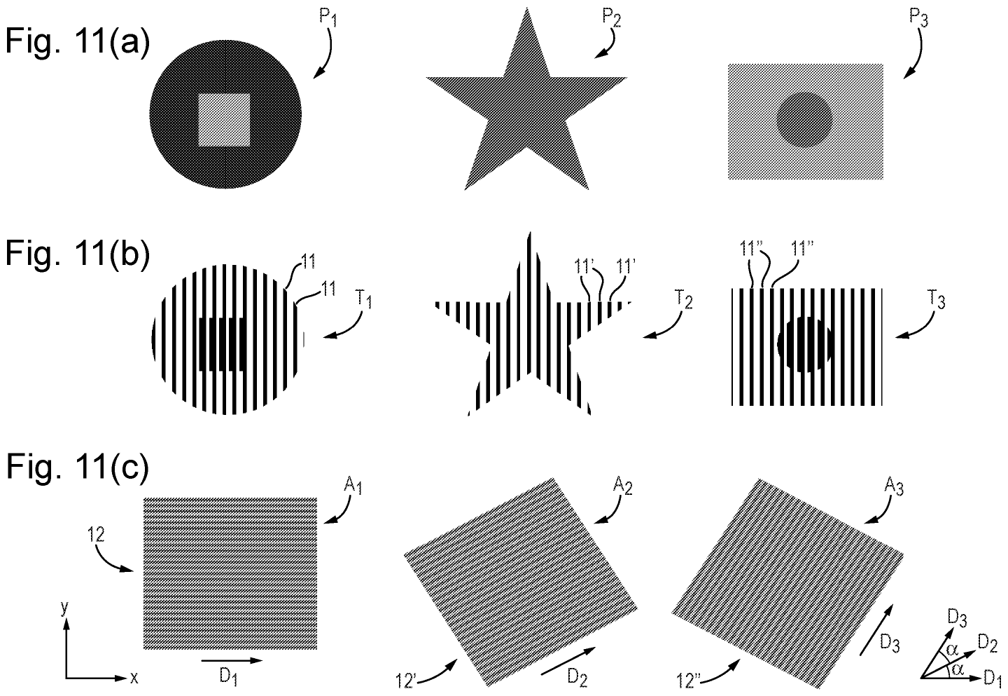

FIG. 11 depicts (a) three exemplary source images as may be used in embodiments of optical device; (b) three corresponding templates of regions formed based on the source images; and (c) three arrays of light redirecting elements, one for each image; all in plan view;

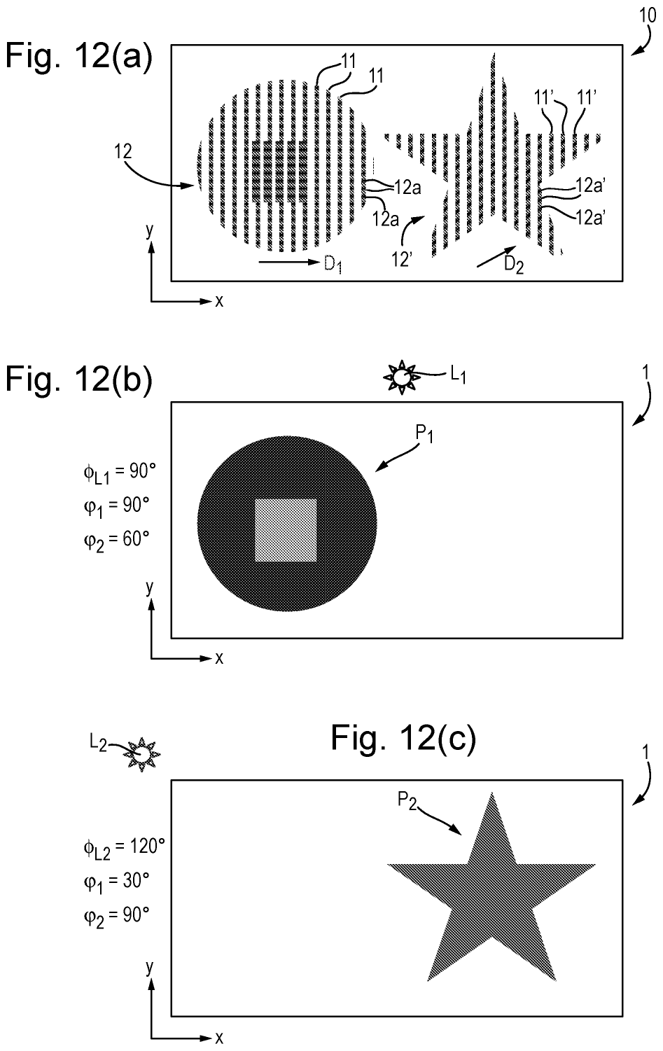

FIG. 12 shows (a) a light redirecting layer forming part of a further embodiment of an optical device; (b) the appearance of the optical device at a first illumination angle; and (c) the appearance of the optical device at a second illumination angle; all in plan view;

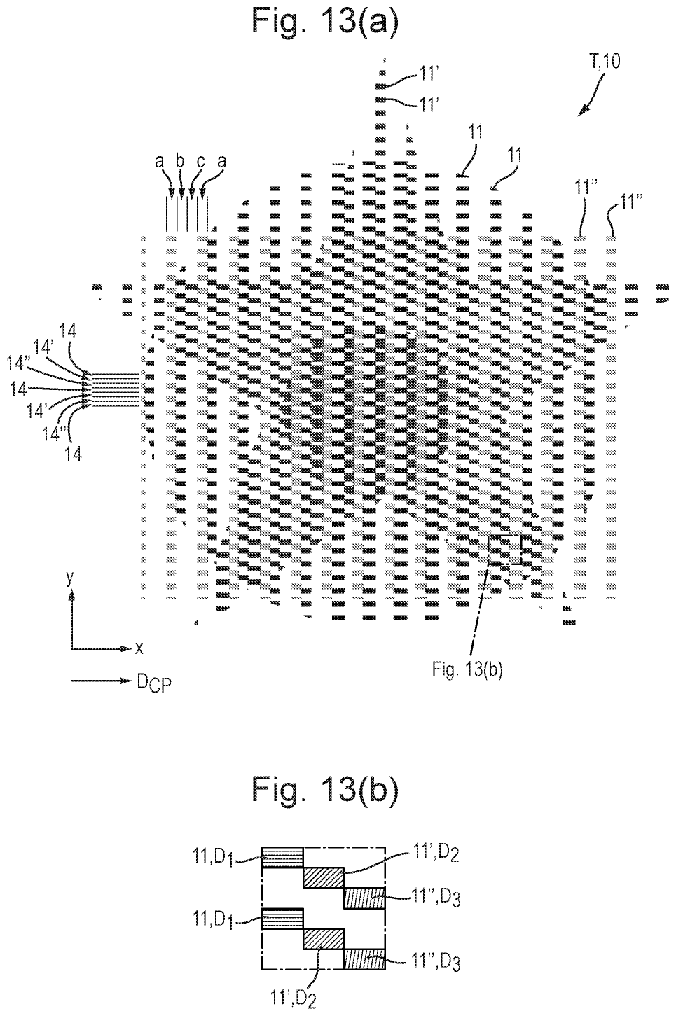

FIG. 13 shows a light redirecting layer forming part of another embodiment of an optical device, in plan view;

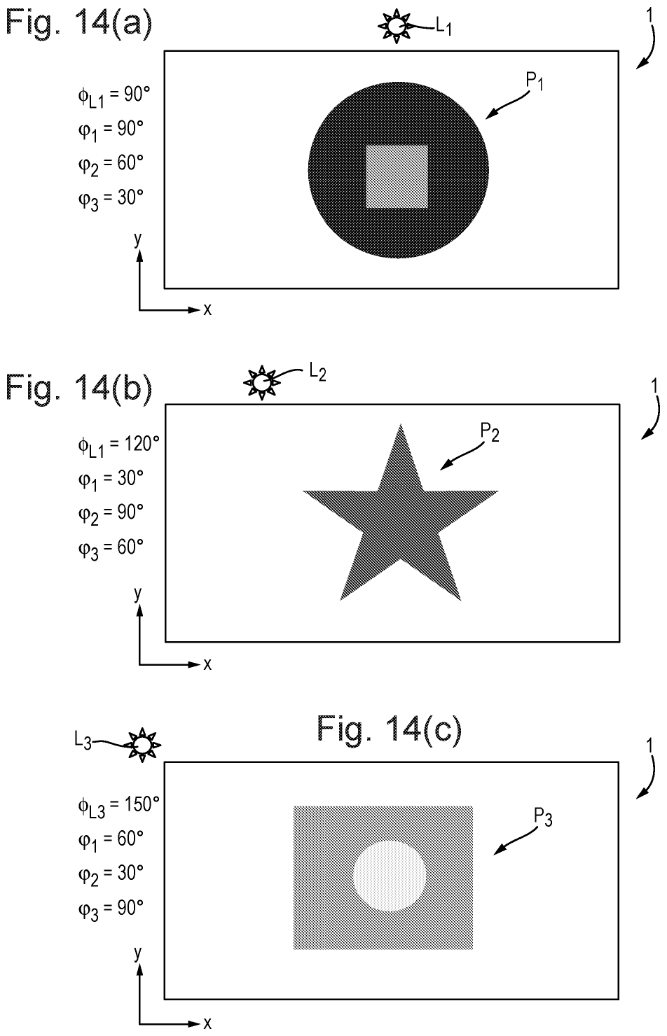

FIG. 14 shows (a) the appearance of the optical device of FIG. 13 at a first illumination angle; (b) the appearance of the optical device of FIG. 13 at a second illumination angle; and (c) the appearance of the optical device of FIG. 13 at a third illumination angle; all in plan view;

FIGS. 15, 16 and 17 depict exemplary sets of images as may be used in embodiments of optical devices;

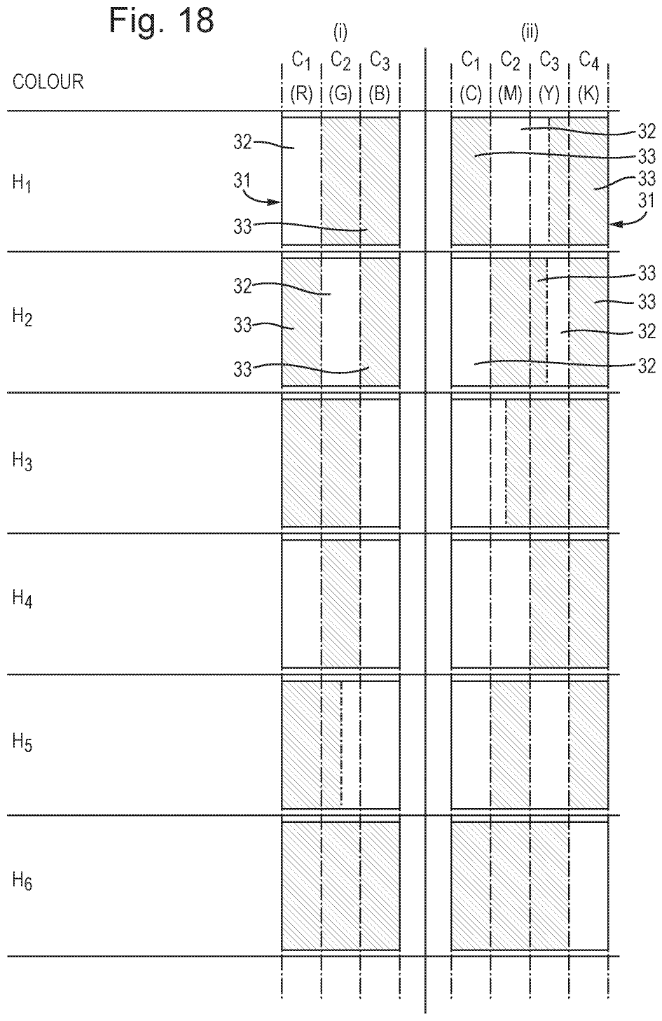

FIG. 18 illustrates a portion of an exemplary look-up table as may be used in preferred implementations of the FIG. 3 method;

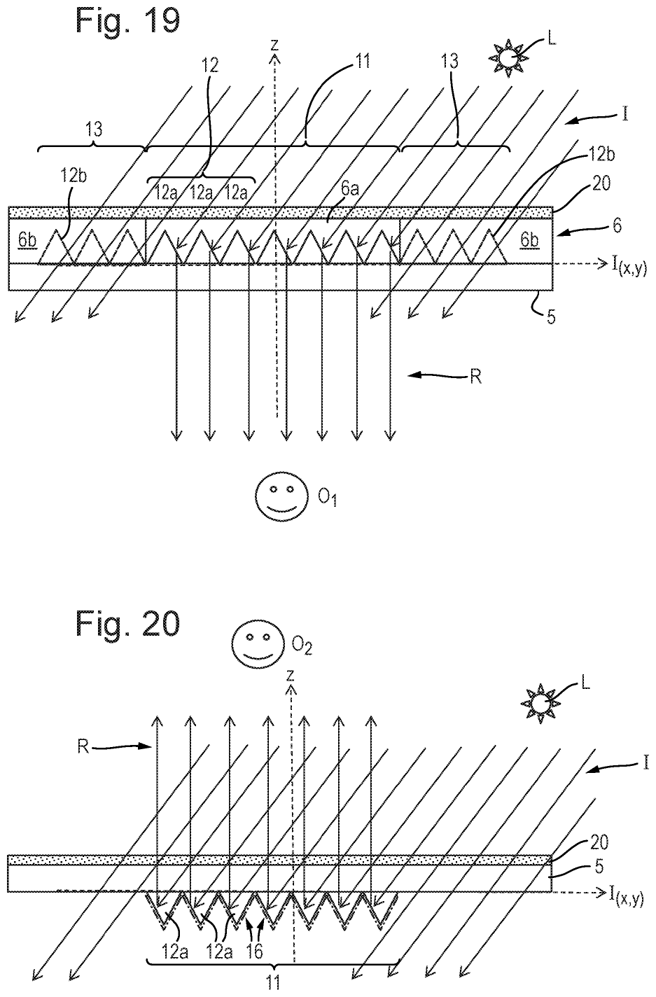

FIGS. 19 and 20 show cross-sections through two further embodiments of optical devices, along a plane containing the incident light beam, in transmitted and reflected light respectively;

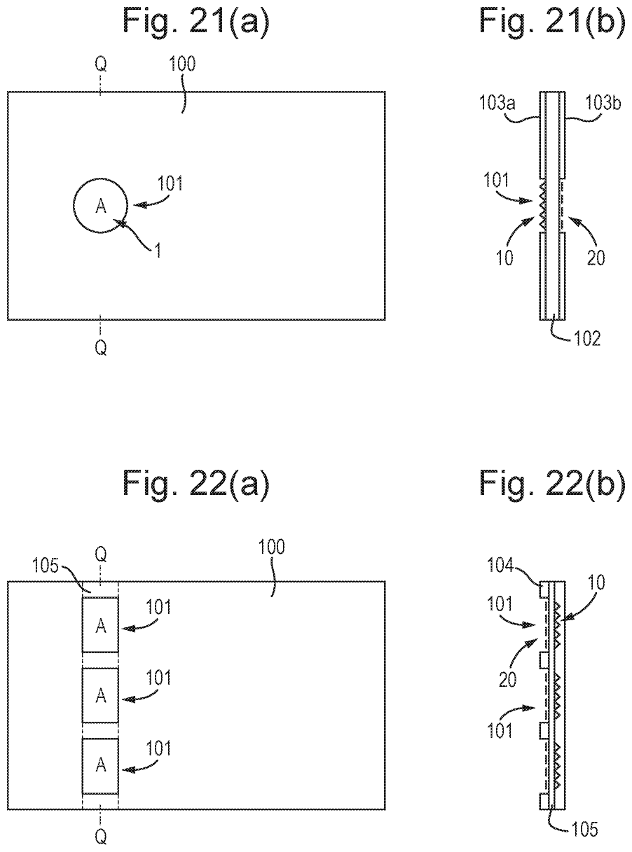

FIGS. 21, 22 and 23 show three exemplary articles carrying optical devices in accordance with embodiments of the present invention (a) in plan view, and (b) in cross-section; and

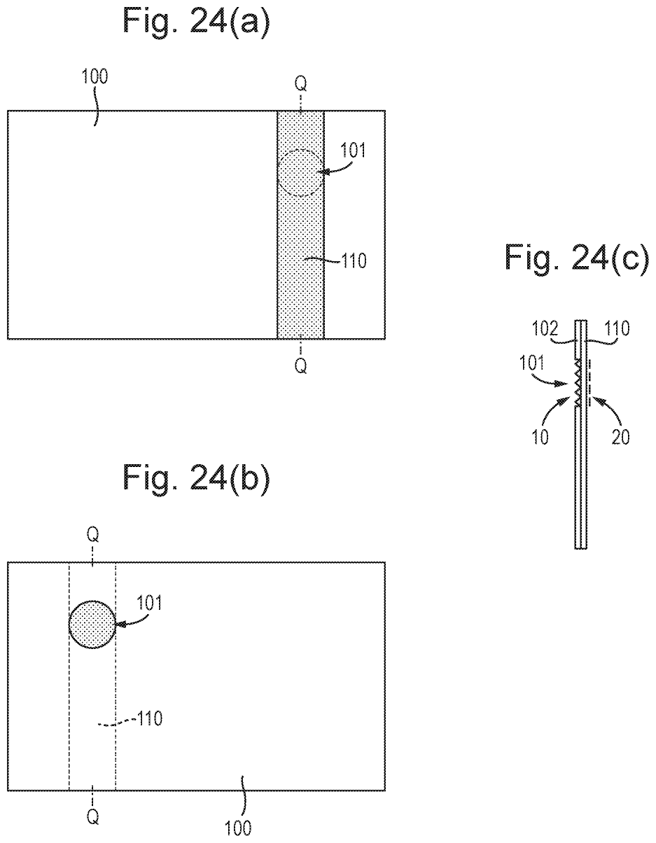

FIG. 24 illustrates a further embodiment of an article carrying an optical device in accordance with the present invention, (a) in front view, (b) in back view and (c) in cross-section.

The ensuring description will focus in the main part on optical devices in the form of security devices. However it will be appreciated that the devices and methods disclosed herein could also be used, or adapted for use, in other applications including those with purely decorative functions as mentioned above.

To aid understanding of the ensuing description, FIG. 1 shows an exemplary light redirection layer 10 and denotes directions and angles that will be referred to hereinafter. FIG. 1(a) shows the light redirection layer 10 in perspective view, illustrating it lying in the x-y plane with its normal parallel to the z-axis. In this example the light redirection layer is configured to operate in a transmissive manner and so a light source L is depicted at an off-normal position on the positive z-axis side of the light redirection layer 10, while an observer O₁ is located on the opposite (negative z-axis) side of the light redirection layer 10, on or close to the device normal (z-axis). It should be appreciated that all the same notation would apply to a reflective-type device, except the observer O₁ would be located on the same side as the light source L (positive z-axis). In this example the light redirection layer 10 is depicted as having a circular first region 11 containing a first array 12 of light redirection elements. Outside the first region 12, the light redirection layer 10 is void of such elements.

The incident light beam l from the light source L lies in a plane (containing the z-axis) which intersects the x-y plane of the device along the line I_{(x,y)}. The “tilt” angle between the light source and the device normal, θₗ, can take any value without the incident light source leaving that plane. It is the (absolute) rotational angle ϕₗ made between the direction I_{(x,y)} and the device orientation (defined here by the x-axis) which will determine the appearance of the device and is therefore of importance. Moreover, for the first region 11 what is important is the (relative) rotational angle φ₁ between the direction D₁ along which the primary axes of the first array 12 of light redirection elements lie, and the direction I_{(x,y)}. If the angle φ₁ is substantially 90 degrees, the first array 12 of light redirection elements will act to redirect the incident light towards the device normal, thereby causing the first region 11 to appear illuminated to observer O₁ relative to the rest of the device. On the other hand, if the angle φ₁ is different from 90 degrees there will be no such relative illumination.

FIG. 2 illustrates this illumination mechanism, showing a first embodiment of an optical device 1 in cross-section, along the line I_{(x,y)} for φ₁=90 degrees. In other words, the first direction D₁ is perpendicular to the plane of the page, extending towards the reader. The light redirection layer 10, comprising a first array 12 of light redirecting elements 12a, filling a first region 11 and absent elsewhere, is here disposed on one surface of a transparent substrate 5. A colour layer 20, comprising alternating strips of at least two different colours (not shown in FIG. 2), is disposed on the opposite surface of the substrate 5. The colour strips could have any orientation relative to the axes of the light redirecting elements 12a.

Incident light l from light source L striking the first region 11 is redirected by the light redirecting elements towards the device normal and hence towards the observer O₁. Outside the first region 11, there is no such redirection. As such, to the observer O₁, the first region 11 will appear illuminated relative to the rest of the device. For example, if the first region 11 is a circle (as shown in FIG. 1), the observer O₁ will see a contrast defining a bright circular area against a dark background. Moreover, the bright circle will be coloured by the colour layer 20, thereby forming a first image displayed by the device. It will be appreciated that, if the device 1 were to be rotated relative to the light source such that φ₁ took on a value other than 90 degrees, the first array 12 of elements 12a would no longer redirect the incident light as shown in FIG. 2, such that there would be no relative illumination of the first region. As a result, such rotation causes the first image to appear to switch “on” and “off”, from the point of view of observer O₁.

In this example, since the first region 11 covers a solid circular area such that the light redirecting elements are provided uniformly across that area, all of the colour strips of the colour layer 20 overlapping the circular first region 11 will be equally illuminated. Assuming that the dimensions of the colour strips are such that they are too small to be individually resolved by the naked eye, the result will be a uniform colour across the whole region 11, which is the mixture of all of the colour strips. That is, the first image will be a single-colour image of a circle.

A more complex example, based on the same principles, will now be described with reference to FIGS. 3 to 7. FIG. 3 is a flow diagram setting out selected steps of a preferred method for manufacturing an optical device, and FIGS. 4 to 6 illustrate stages in the method with respect to an exemplary device. FIG. 7 depicts the appearance of the resulting device, at two different illumination angles.

The process begins in step S101 by obtaining a first image which is to be displayed by the finished optical device and, if the image is not already in the form of a pixelated image with pixels of the desired size, it is converted accordingly. Thus the input (source) image could be of any file type such as a bitmap, jpeg, gif or the like, and is preferably a multi-coloured image but this is not essential. For instance the image could be a monochromatic pattern or indicia, or could be a uniform, all-over colour block. The pixel size is selected so that, preferably, the individual pixels are not readily discernible to the naked eye whilst, desirably, keeping the overall number of pixels low so as to keep down the computational demands on the system. For instance, the original source image may be at a high resolution which is beyond that necessary to create a good visual effect in the final device and so step S101 may optionally involve reducing the resolution of the image, e.g. by combining groups of original pixels into single pixels of greater size and applying the average colour of the original pixels to that new pixel. In preferred cases, the pixelated image at the end of step S101 will have a pixel size between 50 and 500 microns, preferably between 100 and 300 microns. For instance, in a particularly preferred example a pixel size of 264×264 microns was adopted and found to produce good results.

FIG. 4(a) schematically depicts an example of a first (source) image P₁ in a first implementation of the method. In this example, the first image P₁ is a two colour image comprising a blue circle 50 surrounding a turquoise square 51. As shown in FIG. 4(b), the image P₁ is made up of a plurality of image pixels 30, optionally generated via a conversion process as described above, each of which is the same size and shape as one another and exhibits a single colour (which for image P₁ will be either blue or turquoise). Two exemplary ones of the image pixels are labelled 30a and 30b.

In step S102, for each image pixel 30, a corresponding template pixel 31 is created, based on the colour of that image pixel 30 in the image P₁. Thus, FIG. 4(b) shows two exemplary template pixels 31a, 31b that are created from respective image pixels 30a, 30b of the first image P₁ in this step. The template pixels 31 each comprise illumination zone(s) 32 and/or non-illumination zone(s) 33, depending on the colour to be exhibited. The illumination and/or non-illumination zones are arranged according to sectors a, b, c, into which each template pixel is virtually divided in the x-axis direction (which will ultimately align with a direction of the colour layer, to be described below). The number of sectors corresponds to the number of different colours in the colour layer—in this example, there are three.

In this example, since image pixels 30a and 30b were of different colours in image P₁ (blue and turquoise respectively), the template pixels 31a and 31b created for each of them will be different from one another. Thus, template pixel 31a comprises an illumination zone 32a which covers the whole of sector c of the pixel (approximately one-third of the pixel area), and a non-illumination zone 33a in the remaining two sectors a and b. Both the illumination zone 32a and the non-illumination zone 33a extend in the y-axis direction from one side of the pixel to the other. Similarly, template pixel 31b comprises an illumination zone 32b which covers approximately half of the pixel area including the whole of sector c and part of sector b, and a non-illumination zone 33b covering the other half, which includes the whole of sector a and the remainder of sector b. As will become apparent below, the illumination zone(s) 32a, 32b represent colour component(s) which will ultimately be illuminated and hence displayed to the observer whilst the non-illumination zone(s) 33a, 33b represent those colour component(s) which will not be displayed by the pixel in the finished device.

Exemplary methods for generating the arrangements of illumination zone(s) 32 and/or non-illumination zone(s) 33 for each template pixel based on the colour of the corresponding image pixel in the original image will be explained below.

The so-generated template pixels 31 are then arranged in accordance with the relative positions of the original image pixels 30 from which each derives, to form a template T₁ defining a first region 11 corresponding to the original pixelated image P₁ (step S103). Thus, FIG. 4(c) schematically shows a template T₁ with a first region 11 based on first image P₁. Each template pixel 31 is placed in the position of the original image pixel 30 from which it was generated, resulting in the case of first image P₁ in a first region 11 formed of continuous lines of illumination zones extending along the y-axis direction, spaced by lines of non-illumination zones as shown. (For the avoidance of doubt, the first region 11 comprises only the illumination zones and not the non-illumination zones, which fall into the area 15 outside the first region 11). The width of the illumination zones (and hence of the lines forming the first region 11) in the x-direction varies based on the colour of the original image pixels. In the outer area corresponding to circular background 50, the lines of first region 11 are relatively narrow, resulting from an array of template pixels matching pixel 31a shown in FIG. 4(b), whereas in the central area corresponding to square 51, the lines of first region 11 are wider, resulting from an array of template pixels matching pixel 31b.

In the next step (S104), a light redirection layer 10 is formed based on the generated template T₁. An exemplary light redirection layer 10 corresponding to the template shown in FIG. 4(c) is depicted in FIG. 5. The light redirection layer 10 comprises a first array 12 of light redirecting elements 12a, which are present only in the area corresponding to the first region 11 already defined. Hence the light redirecting layer comprises lines extending in the y-axis direction of varying width, where the light redirecting elements 12a are present. Outside the first region 11 (i.e. area 15), there are no light redirecting elements.

The nature of the light redirecting elements 12a will be described further below but for now it is sufficient to note that each has a primary axis which are parallel to one another and aligned along a first direction D₁ which here corresponds to the x-axis. However, in other examples, the light redirecting elements 12a could take any other orientation relative to the layout of the first region—for instance, the first direction D₁ could instead be parallel to the y-axis, or make any other angle with the x- and y-axes. Irrespective of the direction D₁, the same first image P₁ will be displayed since this is determined by where the light redirecting elements 12a are present and absent, not by their orientation. What the orientation of the light redirecting elements 12a does influence, however, is at which illumination angle(s) ϕₗ that first image P₁ will be displayed by the device. In the given example, since the first direction D₁ along which primary axes of the elements 12a forming the first array 12 are aligned is parallel to the x-axis, the first array 12 will illuminate an area of the device corresponding to the first region 11 when the light source L is positioned so that the illumination direction I_{(x,y)} is perpendicular to the x-axis—i.e. along the y-axis, as shown.

FIG. 6 shows an exemplary colour layer 20 which, in step S105, can be combined with the light redirecting layer 10 of FIG. 5 to complete the optical device 1. The colour layer 20 comprises a regular array of elongate strips 21 of at least two different colours which alternate with one another periodically in the direction D_{CP} (the direction of colour periodicity), which here is parallel to the x-axis. The long axes of the colour strips extend in the orthogonal direction and hence are aligned with the y-axis, corresponding to the direction in which the lines of the first region 11 extend in the light redirection layer 10. The colour strips 21 do not need to be especially high resolution although are preferably sufficiently narrow that the human eye does not perceive the individual colours but rather sees a mixed colour formed by those colour strips which are visible at any one point, in combination. For instance, in preferred embodiments, each strip 21 may have a width w (in the x-axis direction) of between 20 and 200 microns, preferably between 50 and 150 microns, more preferably between 75 and 125 microns. It is not essential for each of the differently coloured strips to have the same width, but this is preferred.

A minimum of two different colour strips is necessary in order to achieve multiple colours, but in preferred embodiments the colour layer 20 will include strips of at least 3 different colours. In especially preferred embodiments, the colour layer 20 may include strips of three different colours (preferably red, green and blue) or four different colours (preferably cyan, magenta, yellow and “black”—it should be noted that any opaque material can be used to give the appearance of black, since all that is required is that no light passes through). In the example shown in FIG. 6, the colour layer 20 consists of strips of three different colours C₁, C₂, C₃ such as red, green and blue respectively.

The light redirecting layer 10 and the colour layer 20 are each formed in such a way so as to form respective physical layers which overlap one another, the result of which is an optical device 1 shown in plan view in FIG. 7, as it would appear to an observer on or near the device normal. FIG. 7(a) illustrates the appearance of the optical device 1 when the light source L is positioned such that the incident light direction I_{(x,y)} is parallel to the y-axis and hence perpendicular to the first direction D₁ along which the primary axes of the light redirection elements 12a are aligned, i.e. φₗ=90 degrees. Under this viewing condition, the first region 11 of the light redirection layer illuminates the corresponding (overlapping) part of the colour layer 20 with the result that, in the outer part (corresponding to the circular background 50 of the source image P₁), only the blue colour strips 21 of the colour layer 20 are illuminated, whereas in the centre part (corresponding to the square 51 of the source image P₁), both the blue strips and half of each green strip are illuminated. To the observer, the first image P₁ is thereby recreated and displayed by the device 1, comprising a blue circular background surrounding a turquoise square (resulting from the combination of green and blue).

When the illumination angle is changed, either by rotating the device 1 in the x-y plane and/or moving the light source L relative to the device 1, the first image will no longer be displayed to the observer, i.e. it appears to “switch off”. This is shown in FIG. 7(b) which shows the location of the first image in dashed lines. However, since the illumination direction I_{(x,y)} no longer makes an angle of 90 degrees with the first direction D₁, the light redirection elements 12a no longer illuminate the first region 11 and hence no image is seen.

It should be noted that while in the above example, the displayed first image P₁ has the same colours as those of the original (source) image, this is not essential and will only be achieved if the light redirection layer 10 is registered to the colour layer 20 both in terms of skew and translational position in the direction of colour periodicity D_{CP} (here, the x-axis). Whilst skew registration is always preferred, translation registration is only required if accurate reproduction of the original image colours is desired. If the two components are not registered in the direction of colour periodicity, a colour version of the first image P₁ will still be displayed under the viewing conditions described above, but it may be a false colour version of the original image. For example, the circular area 50 may appear red, and the square 51 purple, as a result of the first region 11 illuminating the red and (parts of) the blue colour strips instead of the blue and (parts of) the green strips. Depending on the nature of the first image, this may or may not be desirable.

In practice, the steps S104 of forming the light redirection layer 10 and S105 of forming the colour layer 20 could be performed in either order or simultaneously. For example, the colour layer 20 may be a pre-existing printed layer on a suitable substrate (e.g. paper or polymer) and the light redirection layer 10 could be formed directly thereon, e.g. by printing or another method as described below. Alternatively, the light redirection layer 10 could be formed on a first (transparent) substrate, and the colour layer 20 on a second (transparent) substrate, and then the two overlapped by laminating the substrates together. Further construction options will be described below.

In the above example, the first image P₁ is a simple, two-colour arrangement of geometric shapes. However, exactly the same principles can be applied to any source image, irrespective of its complexity. To illustrate this, FIG. 8 provides a further example in which the first image P₁ is a full colour photographic image as shown in FIG. 8(a)(i). As before, the first image P₁ is either already a pixelated image of the desired resolution or is converted into such a pixelated image in a preliminary step. FIG. 8(a)(ii) shows the image pixels 30 in an enlarged region of the image P₁. Two illustrative image pixels are labelled 30x and 30y. Image pixel 30x is blue-green, whilst image pixel 30y is red.

Each image pixel 30 is then converted into a corresponding template pixel 31 based on its colour, using a process such as that described above. The template pixels are reassembled and the resulting template is shown in FIG. 8(b). FIG. 8(b)(i) shows the full template T₁ whilst FIG. 8(b)(ii) shows an enlarged portion thereof corresponding to the enlarged portion of the source image shown in FIG. 8(a)(ii). It will be seen that image pixels 30x, 30y are each converted into respective template pixels 31x, 31y each having three illumination zones 32x, 32y (denoted by the shaded portions), corresponding to each of three colours to be provided by the colour layer. However in each template pixel 30x, 30y, the relative widths of the three illumination zones 32x, 32y are different so as to give rise to the different desired colours. It may be noted that white portions of the original image P₁ become black in the template T₁, and vice versa. This is because to create white light, all of the colours of an RGB colour layer must be combined through additive colour mixing and hence illuminated in that region. As such the template pixels here comprise a single illumination zone extending across the whole pixel.

FIG. 8(c) shows a portion of an exemplary light redirecting layer 10 formed based on the template T₁ shown in FIG. 8(b). The portion shown corresponds to the enlarged part of the template shown in FIG. 8(b)(ii). A first array 12 of light redirecting elements 12a is formed to fill first region 11, which corresponds to the illumination zones 32 from all of the template pixels combined. The area 15 outside the first region 11 contains no light redirecting elements. In this example, the light redirecting elements 12a have their primary axes aligned in a first direction D₁ which again corresponds to the x-axis, but as before this is not essential and any other orientation of elements 12a could be used, depending on at which illumination angle it is desired that the image be displayed by the device.

FIG. 8(d) shows a portion of a colour layer 20 which can be overlapped with the light redirecting layer 10 to complete the optical device. The colour layer 20 is substantially the same as that described with respect to the previous example and here comprises strips 21 of three colours c₁, c₂ and c₃ which here are red, green and blue. As before, the direction of colour periodicity D_{CP} is parallel to the x-axis. As a result, the lines of light redirecting elements 12 which together form the first region 11 align with the elongate direction of the colour strips. As an example, line 11* of region 11 indicated in FIG. 8(c) is arranged to coincide with colour strip 21* of colour layer 20, which here is red. Due to the varying width of the line 11*, the portion of the device shown will display a colour which is predominately red in the bottom right corner, and predominately green/blue in the top right corner.

As a whole, the resulting device will display a colour version of the first image P₁ when the illumination angle is perpendicular to the first direction, i.e. parallel to the y-axis. When the device is rotated or the light source moved, the first image will appear to switch off.

In the above examples, the light redirecting elements 12a have been depicted as elongate, semi-cylindrical prisms, and this preferred implementation is shown in more detail in FIG. 9(a), which shows a portion of an exemplary light redirecting layer 10. However, many alternative forms of light redirecting elements 12a could be used instead. What is required is a structure which will consistently redirect off-normal incident light in a predictable manner which depends on the illumination direction I_{(x,y)} relative to the orientation of the elements, as a result of reflection and/or refraction. The elements 12a must therefore be anisotropic in the x-y plane. However, beyond this requirement many different types of element are suitable, although elongate, rectilinear (in the x-y plane) structures are preferred.

Desirably, the elements 12a should define an optically active surface which includes at least one face which is at an angle of between zero and 90 degrees to the plane of the device (the x-y plane). This facet angle is denoted as γ in FIG. 9. The amount of light redirection achieved by the elements 12a will depend on this facet angle γ as well as the material from which the elements 12a are formed (in particular the refractive index of the material). Steeper facet angles will refract more than shallow facet angles, but nonetheless good results have also been achieved with relatively flat prism elements, e.g. 2 micron height and 20 microns width). The face should extend uniformly in the primary axis direction D₁ (i.e. there is no variation in the facet angle of the face along this direction). In the case of elements in the form of semi-cylindrical prisms (FIG. 9(a)), each element 12a has two such faces 13a, 13b which meet to continuously form the semi-cylindrical surface of the element. Since these faces are curved, the facet angle γ varies across the width of the element, but will have a value between zero and 90 degree over a substantial part thereof. Incident light striking such semi-cylindrical prisms at an illumination angle of 90 degrees to direction D₁ will be redirected towards the device normal as previous discussed. In contrast, incident light at other angles will either not be redirected or will be diverted in some other direction. FIG. 9(a) shows all the elements 12a to be identical to one another and this will preferably be the case across the whole first array. However it will be appreciated that the elements 12a will be curtailed to varying degrees by the periphery of the first region itself (see FIG. 8(c) for instance), with the result that the actual footprint of each element 12a may vary in practice. Typical widths of the elements 12a are of the order of 10 to 50 microns.

FIGS. 9(b) and (c) depict two further examples of light redirection element arrays 12 which can be used in all embodiments. FIG. 9(b) shows a particularly preferred implementation in which the elements 12a are triangular prisms and hence provide two flat faces 13a and 13b, either or both of which can be arranged to be at the desired facet angle. It should be noted that whilst prisms with a regular triangular base are shown, this is not essential and the opposing faces 13a, 13b could make different facet angles γ with the device plane, e.g. as would be the case in a sawtooth structure.

In FIG. 9(c), the elements 12a are again prisms but here with a cross-section in the form of a trapezium. Again, each element 12a has two flat faces 13a and 13b suitable for redirecting light in the manner described.

It should be noted that, in practice, the elements may or may not precisely conform to the described regular shapes. For instance, if the elements 12a are printed there is likely to be some deviation from the desired shape. However, good results can still be achieved.

The configurations of light redirecting elements shown in FIGS. 9(a), (b) and (c) all have in common that they will redirect light in the desired manner only when it is incident in one direction (perpendicular to their primary axis D₁). This is depicted schematically for all three variants in FIG. 9(d) which is a simplified plan view of the arrays 12. These form of elements 12 will redirect light towards the on-axis observer only when the light source L is positioned as shown with the incident light direction I_{(x,y)} perpendicular to D₁. As such, when the device is rotated relative to the light source L, the image will appear fully illuminated once every 180 degrees of rotation (partial illumination may begin to occur as the device orientation begins to approach the relevant angle, and may continue for some degrees as it moves away from that article). However, it is also possible to provide light redirecting elements 12a which will redirect light in the desired manner at more illumination angles.

Two examples of such light redirecting elements, which could be used in all embodiments, are shown in FIGS. 10(a) and 10(b), each of which shows a portion of an exemplary light redirecting layer 10, in plan view. In FIG. 10(a), the light redirecting elements 12a have the form of square-based pyramids, arranged in a two-dimensional orthogonal grid aligned with the x and y axes. Each element 12a defines four flat faces 13a, 13b, 13c and 13d, each making a facet angle of between zero and 90 degrees with the device plane. Opposing faces 13a and 13b between them define the element's primary axis which is parallel to first direction D_{1A}, here aligned with the x-axis. The other faces 13c and 13d define a secondary axis, which has a different direction D_{1B}, here aligned with the y-axis. The result is that the elements 12a will redirect incident light in the required manner both when the incident light direction I_{(x,y)} is perpendicular to direction D_{1A}, (i.e. parallel to the y-axis), from light source L₁, and when the incident light direction I_{(x,y)} is perpendicular to direction D_{1B} (i.e. parallel to the x-axis), from light source L₂. As such, when the resulting device is rotated relative to the light source, the image will appear illuminated once every 90 degrees of rotation.

In FIG. 10(b), the light redirecting elements are again arranged on an orthogonal grid but have the form of truncated, rectangular based pyramids which are elongate in the x-axis direction. Again, each element 12a has four flat faces 13a, 13b, 13c and 13d, each making a facet angle of between zero and 90 degrees with the device plane, which define corresponding primary and secondary axis aligned in directions D_{1A}, and D_{1B} as before. The resulting array therefore redirects light in the desired manner once every 90 degrees of rotation in the same manner as before. However, due to the elongation, the redirection will be stronger when incident light is perpendicular to the primary axis D_{1A} than to the secondary axis D_{1B}. This is because, per unit area, there will be a greater number of facets 13a, 13b operating in this direction than there are facets 13c, 13d operating in the perpendicular direction.

Other structures which could be used as the light redirecting elements 12a in all embodiments include elongate grooves which could be protrusions on a substrate (e.g. printed lines), or recesses in a substrate surface (e.g. engraved lines).

The first array 12 of light redirecting elements 12a can be formed using various different manufacturing techniques. For example, the light redirecting elements 12a could be formed by printing a suitable transparent material onto a substrate 5, configured such that upon hardening the surface profile of the printed material will adopt the desired shape. Of course, this approach is better suited to the formation of elements 12a with curved rather than flat surfaces since printed material will tend to adopt a curved shape. The printed material could be a physically drying material or could be curable, e.g. by UV irradiation. Suitable printing techniques include screen printing and intaglio printing. Further examples of suitable printing methods and materials can be found in U.S. Pat. No. 7,609,451 or US-A-2011/0116152. Here, a doming resin is applied to a support layer using a printing technique such as flexographic, lithographic or gravure printing. The nature of the doming resin and the volume in which it is applied is configured such that, upon application, the material adopts a dome-shaped profile. Whilst in the above disclosures the structures formed are lenses and have light-focussing properties, the same principles can be used to form light redirection elements suitable for use in the presently disclosed device. Examples of suitable doming resins are mentioned in the above-cited documents and include UV curable polymer resins such as those based on epoxyacrylates, polyether acrylates, polyester acrylates and urethane acrylates. Examples include Nasdar™ 3527 supplied by Nasdar Company and Rad-Cure™ VM4SP supplied by Rad-Cure Corporation.

In other implementations, the light redirecting elements 12a could be formed by stamping or embossing. In both cases, a die will be provided which has a surface defining the desired light redirecting elements in the form of a relief structure. The relief structure on the die will be impressed into a suitable material, such as a layer of transparent polymer, optionally at an elevated temperature to improve the malleability of the material. The die will then be removed from the material, which now carries the desired array of light redirecting elements in its surface profile. Thermoplastic, transparent polymers are particularly suitable for this purpose, such as polypropylene, biaxially orientated polypropylene, polyethylene, polycarbonate, nylon etc.

In a further alternative, the light redirecting elements 12a could be formed by removing material from the surface of a layer, e.g. by mechanical engraving or by laser ablation. Material is removed to leave behind a surface defining the profile of the desired elements in the layer. Polymers such as those mentioned immediately above can also be used in this case.

In particularly preferred embodiments, however, the first array 12 of light redirecting elements 12a is formed by cast-curing. Again, a die defining the desired light redirecting elements in its surface structure will be provided. A curable material in a fluid state is then brought into contact with the die so as to fill the depressions in its surface structure, and while in contact the material is at least partially cured so as to retain the structure. In practice, the curable material may either be applied directly to the die and a substrate then brought into contact with the material and the die, or the curable material may first be applied to the substrate and then brought into contact with the die. The at least partial curing also assists in affixing the curable material to the substrate such that upon removal from the die, the at least partially cured material is carried by the substrate. A further curing step may be performed to fully fix the shape of the curable material, if necessary.

Suitable curable materials for this purpose include thermally-activated curable materials as well as radiation-curable materials (preferably UV-curable materials). For example, the curable material may comprise a resin which may typically be of one of two types, namely:

a) Free radical cure resins, which are typically unsaturated resins or monomers, pre-polymers, oligomers etc. containing vinyl or acrylate unsaturation for example and which cross-link through use of a photo initiator activated by the radiation source employed e.g. UV.
b) Cationic cure resins, in which ring opening (e.g. epoxy types) is effected using photo initiators or catalysts which generate ionic entities under the radiation source employed e.g. UV. The ring opening is followed by intermolecular cross-linking.

The radiation used to effect curing will typically be UV radiation but could comprise electron beam, visible, or even infra-red or higher wavelength radiation, depending upon the material, its absorbance and the process used. Examples of suitable curable materials include UV curable acrylic based clear embossing lacquers, or those based on other compounds such as nitro-cellulose. A suitable UV curable lacquer is the product UVF-203 from Kingfisher Ink Limited or photopolymer NOA61 available from Norland Products. Inc, New Jersey.

In all cases, the material from which the light redirection elements 12a are formed is preferably transparent at least to visible light (e.g. wavelengths in the range 400 to 700 nm), meaning that it has low (or zero) optical density and substantially does not scatter light, so as not to disrupt the passage of light therethrough (other than the intended redirection). In some cases the material could carry a coloured tint, but this will affect the apparent colour of the device and so this will need to be taken into consideration in the design.

Typically, whichever of the above manufacturing processes is adopted, the first array 12 of light redirection elements 12a will only be formed within (i.e. across the whole of) the first region 11, and not outside the first region. However, in other implementations, the first array 12 could be formed across a larger area and then the light redirection elements 12a falling outside the first region 11 disabled (i.e. rendered non-functional). This can be achieved, for instance, by modifying or destroying the light redirection elements 12a outside the first region 11, e.g. by mechanical force, heating and/or laser irradiation, so that they no longer function as required to illuminate the device. Alternatively, the light redirection elements 12a outside the first region 11 could be “indexed out” by covering their optically active surface(s) with a material of substantially the same refractive index as that of the material from which the light redirection elements 12a are formed (e.g. to within 0.3), which will have the same effect. An example of a device formed in this way will be discussed below with respect to FIG. 15.

In the embodiments described so far, no functional light redirecting elements are provided outside the first region 11. However, in other embodiments (not depicted in the Figures), the area 15 outside the first region 11 could be used to accommodate another set of light redirecting elements, which have a different orientation from that of the first array 12. For example, if the whole area 15 outside the first region 11 were filled with light redirecting elements having their primary axis orthogonal to that of the first array 12 in the first region 11, this will create a negative version of the first image P₁ which is illuminated when the incident light direction is parallel to the primary axis of the first array 12. For example, referring to the FIG. 5 example, if the area 15 were provided with light redirecting elements having their primary axis parallel to the y-axis (not shown), then as the device is rotated relative to the light source L, the first image P₁ will be seen in its original colour (assuming there is register between the light redirection layer 10 and the colour layer 20, as described above) at two positions, separated by 180 degrees. At 90 degrees between those positions, a negative coloured version of the same image will be displayed—e.g. the circular background 50 will be red and the central square will be orange/brown. This is because, at the appropriate illumination angle, the second set of light redirecting elements provided in area 15 will illuminate those parts of the colour layer 20 which the first array 12 of light redirecting elements 12a does not. It will be appreciated that the two sets of light redirecting elements need not be orthogonal to one another but could have any other relative (non-zero) angle, which will determine the angular separation between the viewing conditions at which each version of the first image is displayed.

In still further embodiments, similar principles can be applied to enable the optical device to display a plurality of images, each at a respective illumination angle. To illustrate this, FIG. 11 introduces three images P₁, P₂ and P₃, of which two or more may be displayed by a device sequentially as explained below. FIG. 11(a) shows the three source images. The first image P₁ is as already described with respect to FIG. 4(a) and comprises a blue circle surrounding a turquoise square. The second image P₂ is a red star. The third image P₃ is a green rectangle surrounding a yellow circle.

FIG. 11(b) shows three templates T₁, T₂ and T₃ formed based on the respective images P₁, P₂ and P₃ using the same method as described above with respect to FIGS. 4(a), (b) and (c). That is, the above-described method is repeated for each of the three images. Each image may be processed in series or in parallel depending on the computational capacity available. The result is a template for each image which defines a corresponding region 11, 11′, 11″ within which light redirecting elements are to be provided which will illuminate that image.

However, the light redirecting elements provided within each respective region 11, 11′, 11″ must have different orientations in the device (x-y) plane so that each image will be illuminated at a different illumination angle. Thus, FIG. 11(c) schematically depicts three exemplary array layouts A, A′ and A″ of light redirection elements 12, 12′ and 12″, one for each image. To produce the light redirection layer for each image, its corresponding region 11, 11′, 11″ as defined by its template will be filled by light redirecting elements arranged as shown in the respective array layout A, A′, A″. Essentially, the light redirection layer will be the convolution of the respective region 11, 11′, 11″ with the respective array layout A, A′, A″. The primary axis of the light redirecting elements in the first array 12 is along a first direction D₁ (here, the x-axis), while the primary axis of the light redirecting elements in the second array 12′ is along a different, second direction D₂, and the primary axis of the light redirecting elements in the third array 12″ is along another different direction D₃. Preferably, the angular distance a between each of the directions D₁, D₂, D₃ is approximately equal so that, as the device is rotated, the different images will be displayed in sequence at approximately evenly spaced intervals. For instance, in the present example, direction D₂ lies at 30 degrees from the x-axis, and direction D₃ at 60 degrees, so a has a constant value of 30 degrees. Applying the principles set out above, this will result in (only) the first image P₁ being illuminated when the illumination direction I_{(x,y)} is along the y-axis (ϕₗ=90 degrees); the second image P₂ being illuminated when the illumination direction I_{(x,y)} is moved such that ϕₗ=120 degrees; and the third image P₃ being illuminated when the illumination direction I_{(x,y)} is changed to ϕₗ=150 degrees.

The various images can be arranged so as to be displayed in different areas of the device. Such an embodiment is shown in FIG. 12, where FIG. 12(a) depicts the light redirection layer 10 and FIGS. 12(b) and (bc show the appearance of the complete optical device 1 at two different illumination angles. All are shown in plan view from the point of view of an observer on or near the device normal. In this example, the optical device is configured to display only two images, namely the first and second images P₁ and P₂ described in relation to FIG. 11, but the same principle can be extended to include any number of images. As illustrated in FIG. 12(a), the light redirection layer 10 comprises a first region 11 across which a first array 12 of light redirection elements 12a extends, their primary axis lying along a first direction D₁ which is parallel to the x-axis. The light redirection layer 10 further comprises a second region 11′ across which a second array 12′ of light redirection elements 12a′ extends, their primary axis lying along a second direction D2 which is at 30 degrees to the x-axis. The first and second regions sit adjacent to one another in different areas of the device. The colour layer 20 (not shown) will extend at least across both regions, preferably across the whole device.

FIG. 12(b) shows the appearance of the device when illuminated by a first light source L₁ positioned such that the incident light direction I_{(x,y)} is parallel to the y-axis (ϕₗ=90 degrees). This means that the incident light will be perpendicular to the first direction D₁ (φ₁=90 degrees) and as such the first image P₁ will be illuminated and displayed. Since the incident light is not perpendicular to the second direction D₂ (φ₂=60 degrees), the second image P₂ will not be visible. With the light source moved to a different position L₂ (ϕₗ=120 degrees), as shown in FIG. 12(c), now the second image P₂ will be displayed and not the first. This is because the incident light direction I_{(x,y)} is now perpendicular to second direction D₂ (φ₂=90 degrees) and not to first direction D₁ (φ₁=30 degrees). Hence as the device is rotated back and forth, the appearance of the device will appear to switch between the first and second images P₁, P₂, located in different areas of the device.

In other embodiments, it is desirable for all or some of the plurality of images to be displayed in the same area of the device, so that to an observer each image appears to be replaced by the next as the device is rotated. This may be particularly appropriate where the images combine to form an animation type effect.

FIGS. 13 and 14 illustrate an embodiment of such an optical device. In this example, the device is configured to display three images in sequence, namely the first, second and third images discussed above with respect to FIG. 11. Templates of the first, second and third regions 11, 11′, and 11″ are formed using the same process as discussed above. The three regions are then interlaced together to form a complete template T for the light redirecting layer, as shown in FIG. 13(a). The process of interlacing two or more images (such as the region templates) is already known and any of the available techniques, e.g. existing software packages, can equally be applied to the regions 11, 11′ and 11″ generated by the presently disclosed technique, as to any other set of input images. Interlacing takes place by first dividing each region 11, 11′ and 11″ into elongate slices 14, 14′, 14″, aligned with the direction of colour periodicity D_{CP} in the planned colour layer 20. In this case, this is parallel to the x-axis. The width of the elongate slices in the y direction will depend on the resolution with which the light redirecting elements can be formed and on the number of images to be interlaced. In preferred examples, the width of each elongate slice in the x-direction may be between 1 and 100 microns, preferably between 1 and 50 microns, more preferably between 10 and 30 microns.

Selected slices 14, 14′, 14″ from each region 11, 11′, 11″ are then interleaved with one another to form an interlaced template comprising slices from all the regions, corresponding to the images to be displayed by the finished device over the full range of illumination angles. For a three-channel device, every third slice from each region will be selected, and the remainder discarded. The selected slices from each region with then be arranged to alternate with one another in the y-axis direction to form the interlaced template T, as shown schematically in FIG. 13. Thus the interlaced template T contains slices from all three of the regions 11, 11′, 11″, including the non-discarded portions of the illumination zones and non-illumination zones 33 in each. Hence slices 14 are taken from the first region and derive from image P₁, whilst slices 14′ are taken from the second region 11′ and derive from image P₂, and slices 14″ are taken from the third region 11″ and derive from image P₃.

It will be appreciated that, should it be desired to form a device with a different number of channels (and hence images), the process can readily be adopted to do so by dividing each region into an appropriate number of slices and selecting slices accordingly. Any number of images can be interleaved in this way, the only limit being the resolution with which the light redirection layer 10 will ultimately be formed.

A corresponding light redirection layer 10 can then be formed, comprising regions of light redirecting elements arranged in accordance with the generated template T. As before, all of the portions of the first region 11 (which is now present in the form of elongate strips) will be provided with a first array 12 of light redirecting elements 12a having their primary axis aligned along a first direction D₁ which again is parallel to the x-axis. All of the portions of the second region 11′ will be provided with a second array 12′ of light redirecting elements 12a′ having their primary axis aligned along a second direction D₂, which here lies at 30 degrees to the x-axis. Likewise, all of the portions of the third region 11″ will be provided with a third array 12″ of light redirecting elements 12a″ having their primary axis aligned along a second direction D₂, which here lies at 60 degrees to the x-axis. An enlarged detail of the light redirecting layer 10 is provided in FIG. 13(b) to illustrate this.

The appearance of the finished optical device at three different illumination angles is shown in FIGS. 14(a), (b) and (c). All are shown in plan view from the point of view of an observer on or near the device normal. When the device is positioned relative to a first light source L₁ such that the incident light direction is parallel to the y-axis (ϕₗ=90 degrees), the elongate strips forming the first region 11 are illuminated. In combination, these appear to the observer as a complete or near complete colour version of the first image P₁, due to the narrow width of the slices and their close spacing. The other regions are not illuminated since the incident light direction is not perpendicular to their respective primary axis directions.

Rotating the device 1 or moving the light source to another position L₂ changes the incident light direction to ϕₗ=120 degrees. Now, as shown in FIG. 14(b), the elongate strips forming the second region 11′ are illuminated. In combination, these appear to the observer as a complete or near complete colour version of the second image P₂, due to the narrow width of the slices and their close spacing. The first and third regions are not illuminated since the incident light direction is not perpendicular to their respective primary axis directions. Finally, as shown in FIG. 14(c) when the device is rotated or the light source moved to L₃ such that ϕₗ=150 degrees, now the elongate strips forming the third region 11″ are illuminated. In combination, these appear to the observer as a complete or near complete colour version of the third image P₃, due to the narrow width of the slices and their close spacing. The other two regions are not illuminated. Thus, as the device is rotated through 360 degrees, the same area of the device 1 will appear to display each of the three images P₁, P₂ and P₃, in sequence.

Light redirection layers 10 defining multiple regions 11, 11′ etc. (such as those of FIGS. 12(a) and 13) can be formed using any of the same methods as previously described, including printing, stamping, embossing and cast-curing. For instance, each array of light redirection elements 12, 12′ could be formed in respective, sequential printed workings, preferably in an in-line process. However, in order to achieve accurate registration between the light redirection elements of each array, both in terms of their relative angle and lateral position, it is preferred to use a technique in which all of the regions are formed simultaneously. For instance, in particularly preferred implementations, a master will be formed defining the light redirecting elements of all of the regions thereon, such as a printing plate or a die for embossing or cast-curing. The master will then be used to form the complete light redirecting layer 10 in a single working.

As in the case of single-image devices, in an optical device configured to display multiple images, each image can take any desirable form and can be monochromatic or multi-coloured. In preferred embodiments, between them, the set of images includes at least two colours so as to result in a device which exhibits an optical effect which, overall, is multi-coloured. The images could be unrelated or might have some conceptual link in terms of their information content. For instance, in a two-channel device, one image could be a currency identifier (e.g. “£” or “$”) and the other could be a number denoting a denomination (e.g. “10” or “TEN”). In particularly preferred embodiments, however, the images are configured such that, when viewed in sequence, they collectively exhibit an animation effect, such as expansion/contraction of an object, morphing between one object and another, or a three-dimensional effect in which each image is a view of an object from a different viewpoint.

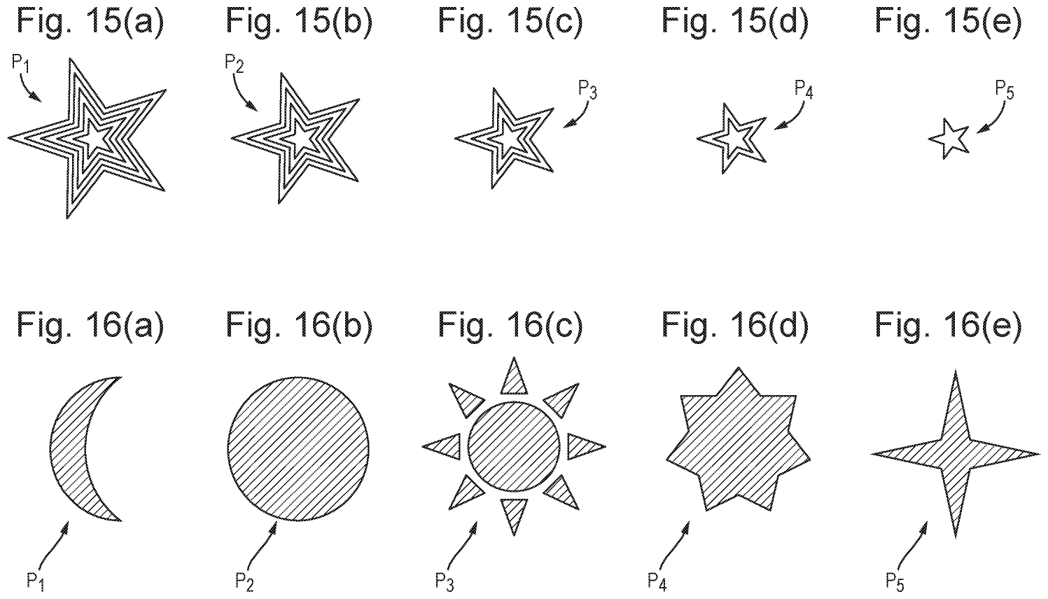

Some examples of images which can be used to create animation effects such as these are shown in FIGS. 15 and 16. FIGS. 15(a) to (e) depict a set of five images P₁ . . . P₅, each of which will be displayed by the device at a different illumination angle. Each image comprises one or more concentric star shaped symbols. Between each image and the next, one of the concentric star shaped symbols is added or removed so that the overall size of the star increases or decreases. When the images are viewed in sequence from P₁ to P₅ or vice versa, the star will appear to shrink or grow. FIGS. 16(a) to (e) depict a series of five images P₁ . . . P₅ which together create a morphing effect. First image P₁ appears as a crescent moon, second image P₂ has the circular shape of a full moon, third image P₃ is a sun shaped symbol with eight radial points, fourth image P₄ is a star with six points, and fifth image P₅ a four-pointed star. As the images are displayed in sequence, the appearance morphs between the crescent moon and four pointed star shape, via those in between.

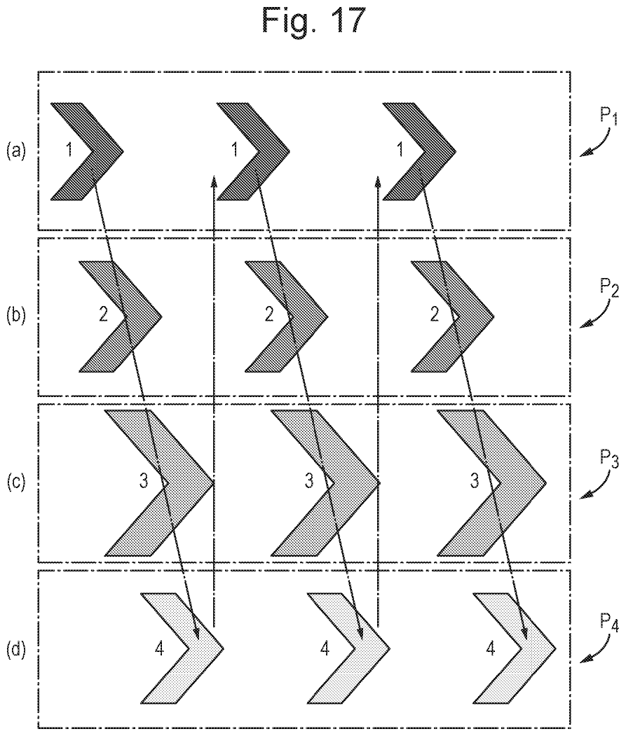

Of course, in order to view the images in the desired sequence, it will be necessary to begin with the optical device in the correct orientation relative to the illumination source. Further, if the device is rotated through a full 360 degrees or more, a “jump” from the end of the sequence directly to the beginning will be visible. To mitigate this, it is preferred to utilise a set of images which give rise to a cyclic effect, i.e. one which repeats so as to form a continuous loop. An example of a set of images which will produce a cyclic effect is shown in FIG. 17. Here, there are four images P₁ . . . P₄, each of which comprises a set of three chevron shapes spaced from one another. The size of the chevrons increases from the first image to the second image and then the third image, before decreasing again in the fourth image (in which the size of the chevrons is the same as in the second image). The position of the chevrons also changes gradually so that in the fourth image, the first chevron is positioned beside the location of the second chevron in the first image. The result is that upon rotating the device, no matter which image is displayed first, the overall appearance will be that of a moving chevron which periodically increases and decreases in size. There will also be no sudden jump in the appearance of the device as it is rotated. Further examples of suitable cyclic image sets can be found in WO2012/153106.

Referring back to FIG. 3, in step S102, the arrangement of illumination and non-illumination zones for each template pixel can be generated in various different ways. One preferred implementation is to use a look-up table which stores in memory a template pixel arrangement for each of a set of available colours. FIG. 18 schematically illustrates a portion of such a look-up table, which in this case provides template pixel arrangements for six exemplary colours H₁ to H₆, for two different exemplary colour layers 20: (i) having red, green and blue colour strips; and (ii) having cyan, magenta, yellow and black colour strips. Each colour H₁ to H₆ may be defined in the memory by a range of colour values, e.g. in CIELab colour space or the like.

In this example, colour H₁ is red and so the stored template pixel arrangement for colour layer (i) includes an illumination zone 32 which will illuminate the red strip, and a non-illumination zone 33 corresponding to the green and blue strips. For colour layer (ii), to achieve the colour red, contributions from the magenta strip and the yellow strip are needed and so the template arrangement includes two non-illumination zones 33, one blocking the cyan strip and the other blocking the black strip (K) plus a portion of the yellow strip. The illumination zone 32 corresponds to the magenta strip and the remaining portion of the yellow strip which are combined by human vision to form red.

Similarly, colour H₂ is green and now the stored template pixel arrangement for colour layer (i) includes two non-illumination zones 33 corresponding to the red and blue strips whilst the green strip will be illuminated by illumination zone 32. For colour layer (ii), to achieve the colour green, contributions from the cyan strip and the yellow strip are needed and so the template arrangement includes two non-illumination zones 33, one blocking the black strip and the other blocking the magenta strip plus a portion of the yellow strip. The two illumination zones 32 illuminate the cyan strip and the remaining portion of the yellow strip which are combined by human vision to form green.

The same principles can be applied to form the rest of the table, where the exemplary colours depicted are: blue (H₃), purple (H₄), turquoise (H₅) and black (H₅).

The use of a look-up table such as that described above has the benefit that it is computationally efficient but the drawback that only a finite number of colours will be represented in the table. Whilst the colour value ranges associated with each of the colours can be arranged to encompass the full colour spectrum such that every input colour can be captured and a suitable template pixel generated, this may reduce the number of different colours in the final images displayed by the device as compared with the originals.

To avoid this, in an alternative implementation, rather than use a look up table, step S102 may involve the use of an algorithm for generating a template for each image pixel directly from the detected colour. For instance, the algorithm may involve determining the proportion of each of the available colour strips (e.g. red, green and blue) that are required to recreate the detected colour, and then selecting appropriate regions of the pixel area corresponding to the colour strips at with the necessary relative proportions. In this way there is no limitation on the number of colours but the process is more computationally expensive.

As mentioned above, translational registration of the light redirection layer 10 and the colour layer 20 is preferred but not essential. Registering the two layers in this way will ensure that the region(s) in which the light redirection elements are present correspond to the intended strips of the colour layer 20, resulting in the intended colours being illuminated. Without such registration, the light redirection elements may illuminate different ones of the colour strips. Nonetheless, the result will still be a version of the original image in the same number of different colours, although these will not be the same colours as in the original. For instance, the end result may appear as a negative version of the original. Such “false colour” images will be adequate in many implementations of the invention although are less preferred especially in cases where the information content of the original image gives rise to an expected colour.

In terms of construction, the optical devices disclosed herein could have various arrangements. The light redirecting layer 10 is preferably disposed in or on a (typically transparent) substrate 5 which acts as a support for the device. The colour layer 20 can be provided on either side of the substrate. For instance, as shown in FIG. 2, the colour layer can be disposed on the opposite side of the substrate from the light redirecting elements. Alternatively, the colour layer 20 could be arranged on the same side of the substrate 5 as the light redirecting elements, e.g. between the array of light redirecting elements and the substrate. In these cases, the optically active surface of the light redirecting elements may be left open to the air, or could be provided with a protective coating. If the latter, it will be necessary to ensure the refractive index of any such coating is sufficiently different from that of the material forming the light redirecting elements to ensure that they are not “indexed out” inside any of the regions.

FIG. 19 shows another embodiment of a security device 1, in cross-section. Here, the light redirecting elements are disposed on a surface of a substrate 5, initially across an area which is greater than the desired first region 11. The array 12 is then coated with a transparent protective layer 6 which is formed of two different materials 6a, 6b, in different parts thereof. In the area correspond to first region 11, the protective layer 6 comprises a first material 6a which has a refractive index different from that of the light redirecting elements 12a (preferably by at least 0.3). This maintains the functionality of those elements in the first region 11. The portions 13 of the array 12 which extend outside the first region 11 are covered by a second material 6b, which has substantially the same refractive index as that of the light redirecting elements 12a. As a result, the elements 12a here are “indexed out” and rendered substantially non-functional. The colour layer 20 is then provided over the protective layer 6, either by direct application thereto (e.g. by printing) or by affixing another substrate (not shown) to which the colour layer 20 has already been applied on top of the protective layer 6.

All the embodiments described so far have been configured to operate primarily in transmission—that is, they are designed to be viewed with the device located between the observer and the light source. However, depending on the configuration of the light redirecting elements, the devices may additionally or alternatively operate in a reflective mode—i.e. with the observer and the light source located on the same side of the device. In still further embodiments, the light redirecting element could be configured to operate exclusively in reflection, e.g. by providing them with a reflective coating, such as a metal layer, which may be opaque. FIG. 20 shows an example of such a device, which otherwise has substantially the same structure as the device of FIG. 2. Here, however, the light redirecting elements 12a are coated with a reflection enhancing layer 16 over their optically active surface (i.e. that defining the faces, discussed above). The reflection enhancing material could be a metal, metal alloy, metallic ink etc, or a high refractive index material such as ZnS. As illustrated in FIG. 20, the reflective surfaces will redirect incident light in the manner already described and hence illuminate the corresponding image as before. However, in such configurations, light passes through the colour layer 20 both before and after being redirected by the light redirecting layer, which can affect the resulting colours displayed by the device and typically results in a false colour version of the image. However, as previously discussed, this may be acceptable in many cases.

Optical devices of the sort described above, in the form of security devices, can be incorporated into or applied to any article for which an authenticity check is desirable. In particular, such devices may be applied to or incorporated into documents of value such as banknotes, passports, driving licences, cheques, identification cards etc.

The security device or article can be arranged either wholly on the surface of the base substrate of the security document, as in the case of a stripe or patch, or can be visible only partly on the surface of the document substrate, e.g. in the form of a windowed security thread. Security threads are now present in many of the world's currencies as well as vouchers, passports, travellers' cheques and other documents. In many cases the thread is provided in a partially embedded or windowed fashion where the thread appears to weave in and out of the paper and is visible in windows in one or both surfaces of the base substrate. One method for producing paper with so-called windowed threads can be found in EP-A-0059056. EP-A-0860298 and WO-A-03095188 describe different approaches for the embedding of wider partially exposed threads into a paper substrate. Wide threads, typically having a width of 2 to 6 mm, are particularly useful as the additional exposed thread surface area allows for better use of optically variable devices, such as that presently disclosed.

The security device or article may be subsequently incorporated into a paper or polymer base substrate so that it is viewable from both sides of the finished security substrate. Methods of incorporating security elements in such a manner are described in EP-A-1141480 and WO-A-03054297. In the method described in EP-A-1141480, one side of the security element is wholly exposed at one surface of the substrate in which it is partially embedded, and partially exposed in windows at the other surface of the substrate.

Base substrates suitable for making security substrates for security documents may be formed from any conventional materials, including paper and polymer. Techniques are known in the art for forming substantially transparent regions in each of these types of substrate. For example, WO-A-8300659 describes a polymer banknote formed from a transparent substrate comprising an opacifying coating on both sides of the substrate. The opacifying coating is omitted in localised regions on both sides of the substrate to form a transparent region. In this case the transparent substrate can be an integral part of the security device or a separate security device can be applied to the transparent substrate of the document. WO-A-0039391 describes a method of making a transparent region in a paper substrate. Other methods for forming transparent regions in paper substrates are described in EP-A-723501, EP-A-724519, WO-A-03054297 and ER-A-1398174.

The security device may also be applied to one side of a paper substrate so that portions are located in an aperture formed in the paper substrate. An example of a method of producing such an aperture can be found in WO-A-03054297. An alternative method of incorporating a security element which is visible in apertures in one side of a paper substrate and wholly exposed on the other side of the paper substrate can be found in WO-A-2000/39391.

Examples of such documents of value and techniques for incorporating a security device will now be described with reference to FIGS. 21 to 24.

FIG. 21 depicts an exemplary document of value 100, here in the form of a banknote. FIG. 21a shows the banknote in plan view whilst FIG. 21b shows the same banknote in cross-section along the line Q-Q′. In this case, the banknote is a polymer (or hybrid polymer/paper) banknote, having a transparent substrate 102. Two opacifying layers 103a and 103b are applied to either side of the transparent substrate 102, which may take the form of opacifying coatings such as white ink, or could be paper layers laminated to the substrate 102.

The opacifying layers 103a and 103b are omitted across an area 101 which forms a window within which the security device 1 is located. As shown best in the cross-section of FIG. 21b, a light redirecting layer 10 is provided on one side of the transparent substrate 102, and a colour layer 20 is provided on the opposite surface of the substrate. The light redirecting layer 10 and image colour layer 20 are each as described above with respect to any of the disclosed embodiments, such that the device 1 displays one or more images in window 101 upon rotation of the device (an image of the letter “A” is depicted here as an example). It should be noted that in modifications of this embodiment the window 101 could be a half-window with the opacifying layer 103b continuing across all or part of the window over the security device 1. In this case, the window will not be transparent but may (or may not) still appear relatively translucent compared to its surroundings. Half-windows are less preferred since the opacifying layer will typically introduce a scattering effect which may diminish the effect of the light redirecting layer. However acceptable results may still be achievable depending on the desired design. The banknote may also comprise a series of windows or half-windows. In this case the security device could be configured to display different images in different ones of the windows.

FIG. 22 shows such an example, although here the banknote 100 is a conventional paper-based banknote provided with a security article 105 in the form of a security thread, which is inserted during paper-making such that it is partially embedded into the paper so that portions of the paper 104 lie on either side of the thread. This can be done using the techniques described in EP0059056 where paper is not formed in the window regions during the paper making process thus exposing the security thread in is incorporated between layers of the paper. The security thread 105 is exposed in window regions 101 of the banknote. Alternatively the window regions 101 which may for example be formed by abrading the surface of the paper in these regions after insertion of the thread. The security device is formed on the thread 105, which comprises a transparent substrate with light redirection layer 10 provided on one side and colour layer 20 provided on the other. In this example, the security device is configured to operate in a reflective mode, e.g. having a structure such as that described with respect to FIG. 20 above.

If desired, several different security devices 1 could be arranged along the thread, with different or identical images displayed by each. In one example, a first window could contain a first device, and a second window could contain a second device, each having their light redirecting elements arranged along different (preferably orthogonal) directions, so that the two windows display different effects depending on the illumination angle. For instance, the central window may be configured to display an image when the incident light direction is along the x-axis, whilst the two outer windows may be configured to display images when the incident light direction is along the y-axis.

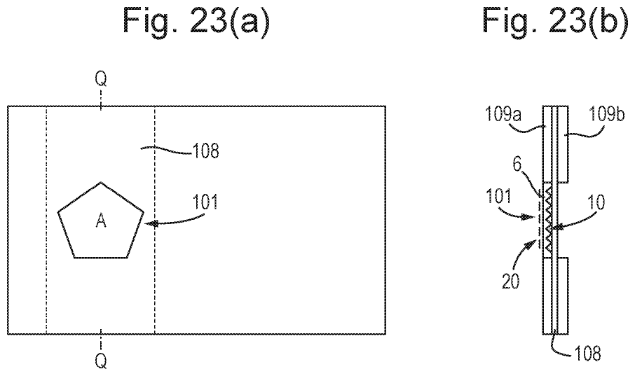

In FIG. 23, the banknote 100 is again a conventional paper-based banknote, provided with a strip element or insert 108. The strip 108 is based on a transparent substrate and is inserted between two plies of paper 109a and 109b. The security device is formed by a light redirecting layer 10 disposed on one side of the strip substrate, with a protective layer 6 and then a colour layer 20 over the top (on the same side of the substrate). The paper plies 109a and 109b are apertured across region 101 to reveal the security device, which in this case may be present across the whole of the strip 108 or could be localised within the aperture region 101.

A further embodiment is shown in FIG. 24 where FIGS. 24(a) and (b) show the front and rear sides of the document 100 respectively, and FIG. 24(c) is a cross section along line Q-Q′. Security article 110 is a strip or band comprising a security device according to any of the embodiments described above. The security article 110 is formed into a security document 100 comprising a fibrous substrate 102, using a method described in EP-A-1141480. The strip is incorporated into the security document such that it is fully exposed on one side of the document (FIG. 24(a)) and exposed in one or more windows 101 on the opposite side of the document (FIG. 24(b)). Again, the security device is formed on the strip 110, which comprises a transparent substrate with a light redirecting layer 10 formed on one surface and colour layer 20 formed on the other.

In FIG. 24, the document of value 100 is again a conventional paper-based banknote and again includes a strip element 110. In this case there is a single ply of paper. Alternatively a similar construction can be achieved by providing paper 102 with an aperture 101 and adhering the strip element 110 on to one side of the paper 102 across the aperture 101. The aperture may be formed during papermaking or after papermaking for example by die-cutting or laser cutting. Again, the security device is formed on the strip 110, which comprises a transparent substrate with a light redirecting layer 10 formed on one surface and colour layer 20 formed on the other.

The security device of the current invention can be made machine readable by the introduction of detectable materials in any of the layers or by the introduction of separate machine-readable layers. Detectable materials that react to an external stimulus include but are not limited to fluorescent, phosphorescent, infrared absorbing, thermochromic, photochromic, magnetic, electrochromic, conductive and piezochromic materials.

The presence of a reflective material 16 such as a metal in the security device can be used to conceal the presence of a machine readable dark magnetic layer, or the reflective material 16 itself could be magnetic. When a magnetic material is incorporated into the device the magnetic material can be applied in any design but common examples include the use of magnetic tramlines or the use of magnetic blocks to form a coded structure. Suitable magnetic materials include iron oxide pigments (Fe₂O₃ or Fe₃O₄), barium or strontium ferrites, iron, nickel, cobalt and alloys of these. In this context the term “alloy” includes materials such as Nickel:Cobalt, Iron:Aluminium:Nickel:Cobalt and the like. Flake Nickel materials can be used; in addition Iron flake materials are suitable.

Typical nickel flakes have lateral dimensions in the range 5-50 microns and a thickness less than 2 microns. Typical iron flakes have lateral dimensions in the range 10-30 microns and a thickness less than 2 microns.

In an alternative machine-readable embodiment a transparent magnetic layer can be incorporated at any position within the device structure. Suitable transparent magnetic layers containing a distribution of particles of a magnetic material of a size and distributed in a concentration at which the magnetic layer remains transparent are described in WO03091953 and WO03091952.

1-44. (canceled)

45. An optical device, comprising:
a colour layer which comprises elongate strips of at least two different colours alternating with one another periodically along a direction of colour periodicity, the elongate strips extending along the direction which is orthogonal to the direction of colour periodicity; and
a light redirecting layer overlapping the colour layer, and defining at least a first image to be exhibited by the optical device, the light redirecting layer comprising at least a first array of refractive and/or reflective anisotropic light redirecting elements extending across a first region of the light redirecting layer and being absent elsewhere, the anisotropic light redirecting elements of the first array each having a primary axis orientated along a first direction lying in the plane of the optical device and being configured such that an incident light beam lying in a plane perpendicular to the first direction and from a light source off the normal of the optical device will be redirected by the anisotropic light redirecting elements towards the normal of the optical device but within the same plane, whereas an incident light beam lying in a plane which is not perpendicular to the first direction and from a light source off the normal of the optical device will either not be redirected, or will be redirected by the anisotropic light redirecting elements out of the plane of the incident light beam;
whereby for a viewer substantially on the normal of the optical device, when the incident light beam lies in a plane perpendicular to the first direction and is from a light source off the normal of the optical device, portions of the colour layer which overlap the first region of the light redirecting layer are illuminated by the anisotropic light redirecting elements relative to the remainder of the colour layer;
and wherein the first region is arranged such that, at each location across the first region, the relative proportions of the at least two different colours of the colour layer which are illuminated by the anisotropic light redirecting elements are configured to exhibit in combination a colour of a corresponding pixel of the first image;
such that for a viewer substantially on the normal of the optical device, when the incident light beam lies in a plane perpendicular to the first direction and is from a light source off the normal of the optical device, a colour version of the first image will be exhibited by the device.

46. An optical device according to claim 45, wherein each anisotropic light redirecting element comprises a structure having at least one planar or curved face which extends uniformly along the primary axis and all or part of which makes a facet angle of more than zero degrees and less than or equal to 90 degrees with the plane of the device wherein each anisotropic light redirecting element comprises a structure having at least two planar or curved faces each extending uniformly along the primary axis and all or part of which making a facet angle of more than zero degrees and less than or equal to 90 degrees with the plane of the device, opposing one another.

47. An optical device according to claim 46, wherein each anisotropic light redirecting element additionally has a secondary axis in the plane of the device, maxing an angle of more than zero degrees and less than or equal to 90 degrees with the primary axis, and the structure further comprises at least one planar or curved face which extends uniformly along the secondary axis and all or part of which makes a facet angle of more than zero degrees and less than or equal to 90 degrees with the plane of the device.

48. An optical device according to claim 45, wherein the anisotropic light redirecting elements are prisms extending along their primary axis and having a cross-section which is a triangle, a trapezium, an arch, a circular segment or an elliptical segment.

49. An optical device according to claim 45, wherein each location of the first region, corresponding to a respective pixel of the first image, comprises one or more illumination zones arranged in sectors, one for each of the colours of the colour layer, along the direction of colour periodicity, the extent of the illumination zone(s) within each sector being configured such that, when illuminated by the first region, the area of the colour layer overlapping the location displays the colour of the respective pixel of the first image.

50. An optical device according to claim 45, wherein the light redirecting layer defines a plurality of images to be exhibited by the optical device, including the first image, the light redirecting layer comprising a corresponding plurality of arrays of refractive and/or reflective anisotropic light redirecting elements, each array extending across a respective region of the light redirecting layer and being absent elsewhere, the anisotropic light redirecting elements of each respective array all having a primary axis orientated along a direction lying in the plane of the optical device, which direction is different for each array, the anisotropic light redirecting elements of each respective array being configured such that an incident light beam lying in a plane perpendicular to the primary axis direction and from a light source off the normal of the optical device will be redirected by the anisotropic light redirecting elements towards the normal of the optical device but within the same plane, whereas an incident light beam lying in a plane which is not perpendicular to the primary axis direction and from a light source off the normal of the optical device will either not be redirected, or will be redirected by the anisotropic light redirecting elements out of the plane of the incident light beam,
and wherein each respective region is arranged such that, at each location across the region, the relative proportions of the at least two different colours of the colour layer which are illuminated by the anisotropic light redirecting elements are configured to exhibit in combination a colour of a corresponding pixel of the respective image;
such that for a viewer substantially on the normal of the optical device, when the angle of the incident light beam from a light source off the normal of the optical device is changed, colour versions of each of the plurality of image will be exhibited sequentially by the device.

51. An optical device according to claim 50, wherein each of the plurality of regions has the form of a set of elongate slices aligned substantially parallel to the direction of colour periodicity and the sets of elongate slices are interlaced with one another in the direction orthogonal to the direction of colour periodicity, whereby the plurality of images are located in the same area of the optical device as one another.

52. An optical device according to claim 50, wherein the plurality of images are configured to display when viewed in sequence an animation, movement, morphing, three-dimensional, enlarging or contracting effect.

53. An optical device according to claim 45 wherein at least the first image is a multi-coloured image.

54. An optical device according to claim 45, wherein the colour layer comprises elongate strips of at least three different colours which alternate with one another periodically in the direction of colour periodicity.

55. A security article comprising an optical device according to claim 45, wherein the optical device is a security device and the security article is formed as a security thread, strip, foil, insert, label or patch.

56. A security document comprising an optical device according to claim 45, wherein the optical device is a security device, or a security article formed as a security thread, strip, foil, insert, label or patch, wherein the security document is formed as a banknote, cheque, passport, identity card, certificate of authenticity, fiscal stamp or another document for securing value or personal identity.

57. A method of manufacturing an optical device, comprising:
(a) providing a colour layer which comprises elongate strips of at least two different colours alternating with one another periodically along a direction of colour periodicity, the elongate strips extending along the direction which is orthogonal to the direction of colour periodicity;
(b) generating a template for a light redirecting layer, which template defines at least a first region thereof, corresponding to a first image to be exhibited by the optical device, by:
(b1) providing a version of the first image comprising a plurality of image pixels, each image pixel exhibiting a uniform colour;
(b2) for each image pixel of the first image, creating a corresponding 1 template pixel based on the colour of the respective image pixel, each template pixel comprising an arrangement of one or more illumination zones and/or one or more non-illumination zones, different arrangements of the of one or more illumination zones and/or one or more non-illumination zones in different ones of the template pixels defining different respective colours;
(b3) arranging the template pixels in accordance with the positions of their corresponding image pixels in the first image to form the template for the light receiving layer, the illumination zones of the template pixels in combination forming the first region thereof which defines the first image;
(c) forming a light redirecting layer in accordance with the generated template, the light redirecting layer comprising at least a first array of refractive and/or reflective anisotropic light redirecting elements extending across a first region of the light redirecting layer corresponding to the first region of the template and being absent elsewhere, the anisotropic light redirecting elements of the first array each having a primary axis orientated along a first direction lying in the plane of the optical device and being configured such that an incident light beam lying in a plane perpendicular to the first direction and from a light source off the normal of the optical device will be redirected by the anisotropic light redirecting elements towards the normal of the optical device but within the same plane, whereas an incident light beam lying in a plane which is not perpendicular to the first direction and from a light source off the normal of the optical device will either not be redirected, or will be redirected by the anisotropic light redirecting elements out of the plane of the incident light beam; and
(d) overlapping the colour layer and the light redirecting layer to form the optical device;
whereby for a viewer substantially on the normal of the optical device, when the incident light beam lies in a plane perpendicular to the first direction and is from a light source off the normal of the optical device, portions of the colour layer which overlap the first region of the light redirecting layer are illuminated by the anisotropic light redirecting elements relative to the remainder of the colour layer, such that for a viewer substantially on the normal of the optical device, when the incident light beam lies in a plane perpendicular to the first direction and is from a light source off the normal of the optical device, a colour version of the first image will be exhibited by the device.

58. A method according to claim 57, wherein each template pixel is divided in the direction of colour periodicity into at least two sectors, one for each of the at least two different colours of the colour layer, and the one or more illumination zones and/or one or more non-illumination zones of each template pixel are arranged in one or more of the sectors with the relative proportions thereof being based on the colour of the corresponding pixel of the first image.

59. A method according to claim 57, wherein in step (c), either:
the light redirecting layer is formed by printing, embossing, stamping or cast-curing the first array of anisotropic light receiving elements onto a substrate only within the first region; or
the light redirecting layer is formed by providing a substrate carrying the first array of anisotropic light redirecting elements over an area greater than that of the first region, and then disabling the anisotropic light receiving elements outside the first region.

60. A method according to claim 57, wherein in step (b2) either:
each template pixel is created by identifying the colour of the respective image pixel and using a look-up table stored in memory to select an arrangement of one or more illumination regions and/or one or more non-illumination regions corresponding to the identified colour; or
each template pixel is created by identifying the colour of the respective image pixel, identifying what relative proportions of the at least two colours of the colour layer are required to form the identified colour, and using an algorithm to generate an arrangement of one or more illumination regions and/or one or more non-illumination regions which will in combination illuminate the desired relative proportions of the at least two colours of the colour layer.

61. A method according to claim 57, wherein:
the template for the light redirecting layer generated in step (b) defines a plurality of regions thereof, including the first region, each of the regions corresponding to a respective image to be exhibited by the optical device, the template being generated by repeating steps (b1), (b2) and (b3) for each respective image; and
the light redirecting layer formed in step (c) comprises a corresponding plurality of arrays of refractive and/or reflective anisotropic light redirecting elements, each array extending across a respective region of the light redirecting layer and being absent elsewhere, the anisotropic light redirecting elements of each respective array all having a primary axis orientated along a direction lying in the plane of the optical device, which direction is different for each array, the anisotropic light redirecting elements of each respective array being configured such that an incident light beam lying in a plane perpendicular to the primary axis direction and from a light source off the normal of the optical device will be redirected by the anisotropic light redirecting elements towards the normal of the optical device but within the same plane, whereas an incident light beam lying in a plane which is not perpendicular to the primary axis direction and from a light source off the normal of the optical device will either not be redirected, or will be redirected by the anisotropic light redirecting elements out of the plane of the incident light beam,
whereby for a viewer substantially on the normal of the optical device, when the angle of the incident light beam from a light source off the normal of the optical device is changed, colour versions of each of the plurality of images will be exhibited sequentially by the device.

62. A method according to claim 61, wherein step (b) further comprises, after performing step (b3) for each of the images:
(b4) interlacing the plurality of regions by selecting a set of strips aligned substantially parallel to the direction of colour periodicity from each of the regions and interlacing the sets of strips with one another in the direction orthogonal to the direction of colour periodicity that the plurality of regions are located in the same area of the template as one another.

63. A method according to claim 57, wherein step (c) comprises forming a production tool defining each of the plurality of arrays of anisotropic light redirecting elements in a surface thereof, each array extending across a respective region in accordance with the template generated in step (b), and then using the production tool to form the light redirecting layer, whereby the plurality of arrays of anisotropic light redirecting elements are formed simultaneously, wherein, in step (c), the production tool is used to form the light redirecting layer by embossing, stamping or cast-curing.
